(19) United States
(12) Patent Application Publication
(10) Pub. No.: US 2026/0297413 A1
(43) Pub. Date: Oct. 1, 2026

(54) WELLBORE DRILLING COMPOSITIONS

(71) Applicant: Chevron Phillips Chemical Company LP, The Woodlands, TX (US)

(72) Inventors: Mario A. RAMIREZ, Houston, TX (US); Oyindunmola S. DINA, Spring, TX (US); Marcus BANKS, Spring, TX (US); Terrell JENSEN, The Woodlands, TX (US); Kenneth D. HOPE, Kingwood, TX (US); Thomas J. MALINSKI, Porter, TX (US)

(21) Appl. No.: 19/557,064

(22) Filed: Mar. 4, 2026

Related U.S. Application Data
(60) Provisional application No. 63/779,518, filed on Mar. 28, 2025.
(60) Provisional application No. 63/888,081, filed on Sep. 25, 2025.
(60) Provisional application No. 63/904,332, filed on Oct. 23, 2025.
(60) Provisional application No. 63/917,384, filed on Nov. 14, 2025.
(60) Provisional application No. 63/967,980, filed on Jan. 26, 2026.

(51) Int. Cl. C09K 8/28; E21B 7/04; E21B 21/00

(52) U.S. Cl. CPC C09K 8/28; E21B 7/046; E21B 21/00; C09K 2208/28; C09K 2208/34

(57) ABSTRACT

Aspects of the present disclosure generally relate to new drilling compositions and uses thereof. In an aspect, a water-based drilling mud composition is provided. The water-based drilling mud composition includes an aqueous carrier, asphalt sulfonate salt particles, a base oil, and graphene particles. In another aspect is provided a process that includes introducing a composition comprising asphalt sulfonate salt particles, a base oil, and graphene particles to a subterranean formation.

### CROSS-REFERENCE TO RELATED APPLICATIONS

This application claims benefit of and priority to U.S. Provisional Patent Application Ser. No. 63/779,518, filed on Mar. 28, 2025, U.S. Provisional Patent Application Ser. No. 63/888,081, filed on Sep. 25, 2025, U.S. Provisional Patent Application Ser. No. 63/904,332, filed on Oct. 23, 2025, U.S. Provisional Patent Application Ser. No. 63/917,384, filed on Nov. 14, 2025, and U.S. Provisional Patent Application Ser. No. 63/967,980, filed on Jan. 26, 2026, each of which is incorporated herein by reference in its entirety.

### FIELD

Aspects of the present disclosure generally relate to new drilling compositions and uses thereof.

### BACKGROUND

Drilling compositions, such as drilling muds or drilling fluids, are utilized while drilling subsurface wells for the extraction and exploration of natural resources such as oil, natural gas, and water. In operation, the muds or fluids are distributed along or circulated throughout a wellbore to serve a variety of functions. Such functions include the cooling and lubrication of drilling equipment, removing drill cuttings from the wellbore, assisting in the support of drill pipes and drill bits, aiding formation stability, and maintaining the integrity of the wellbore. Accordingly, success of a drilling program relies heavily on drilling compositions.

Drilling compositions typically fall within two categories: water-based drilling compositions and non-aqueous based (oil-based and synthetic-based) drilling compositions. While non-aqueous based drilling compositions provide good lubricity, such compositions are expensive and have environmental drawbacks; consequently, water-based drilling compositions are typically selected. However, conventional water-based drilling compositions suffer from low lubricity. Here, a function of drilling compositions is the management and reduction of frictional forces between the formation and drilling equipment, for example, between the wellbore and the drill string. It is especially important to manage friction to avoid excessive torque and drag on, for example, the drill string. In addition, longer lateral wellbore section lengths are becoming increasingly common. While offering the potential for increased production, longer lateral wellbores present significant technical challenges such as higher frictional forces.

There is a need for new drilling compositions and uses thereof.

### SUMMARY

Aspects of the present disclosure generally relate to new drilling compositions and uses thereof. The inventors found new drilling mud compositions that include, for example, a base oil, asphalt sulfonate salt particles, and graphene particles. Advantageously, drilling mud compositions described herein can exhibit lower coefficients of friction (COF) than state-of-the-art drilling mud compositions. Further, drilling mud compositions described herein can be characterized as having super-lubricity, e.g., a COF of less than 0.1. In addition, drilling mud compositions described herein can significantly reduce wear on drilling equipment such as the drill pipe and the bottom hole assembly. When combined with an aqueous carrier, each of the base oil, the asphalt sulfonate salt particles, and the graphene particles individually have COF values greater than 0.1. However, the combination of the aqueous carrier, the base oil, the asphalt sulfonate salt particles, and the graphene particles shows synergistic results, with COF values less than 0.1.

In an aspect, a water-based drilling mud composition is provided. The water-based drilling mud composition includes an aqueous carrier, asphalt sulfonate salt particles, a base oil, and graphene particles.

In another aspect, a water-based drilling mud composition is provided. The water-based drilling mud composition includes an aqueous carrier, asphalt sulfonate salt particles, a base oil, and graphene particles, the water-based drilling mud composition having: a COF, measured at 100° F., that is at least 5% less than a COF of the water-based drilling mud composition without the graphene particles; a COF, measured at 150° F., that is at least 5% less than a COF of the water-based drilling mud composition without the graphene particles; a COF, measured at 200° F., that is at least 5% less than a COF of the water-based drilling mud composition without the graphene particles; or combinations thereof, the COFs measured according to ASTM Designation G-99-23.

In another aspect, a water-based drilling mud composition is provided. The water-based drilling mud composition has: a COF, measured at 100° F., of about 0.06 or less; a COF, measured at 150° F., of about 0.07 or less; a COF, measured at 200° F., of about 0.04 or less; or combinations thereof, the COFs measured according to ASTM Designation G-99-23.

In another aspect is provided a composition that includes an aqueous material or an oil-based material, asphalt sulfonate salt particles, graphene particles, and a base oil, the base oil different from the oil-based material.

In another aspect, an oil-based drilling mud composition is provided. The oil-based drilling mud composition includes an oil-based carrier, asphalt sulfonate salt particles, graphene particles, and a base oil, the base oil different from the oil-based carrier.

In another aspect is provided a process that includes using a composition comprising asphalt sulfonate salt particles, a base oil, and graphene particles as a drilling fluid, a coiled-tubing fluid, a wellbore fluid, or a completion fluid.

In another aspect is provided a process that includes introducing a composition comprising asphalt sulfonate salt particles, a base oil, and graphene particles to a subterranean formation.

In another aspect, a method of preparing a water-based drilling mud composition is provided. The method includes emulsifying a mixture comprising an aqueous carrier, asphalt sulfonate salt particles, a base oil, and graphene particles to form a water-based drilling mud composition.

In another aspect, a water-based drilling mud composition is provided. The water-based drilling mud includes an oil suspension dispersed in an aqueous carrier, asphalt sulfonate salt particles, graphene particles, an optional surfactant, and an optional suspending agent (e.g., a polymer), the oil suspension comprising a C8 dimer, a C8 trimer, a C10 dimer, a C12 dimer, a C12 trimer, a C14 dimer, mixed C10-C12 dimers, a C14 hydrocarbon, a tall oil fatty acid, a polyalphaolefin, a GTL base oil, dodecene, dodecane, decane, decene, a monounsaturated fatty acid, or combinations thereof.

### BRIEF DESCRIPTION OF THE DRAWINGS

So that the manner in which the above recited features of the present disclosure can be understood in detail, a more particular description of the disclosure, briefly summarized above, can be had by reference to aspects, some of which are illustrated in the appended drawings. It is to be noted, however, that the appended drawings illustrate only exemplary aspects and are therefore not to be considered limiting of its scope, can admit to other equally effective aspects.

FIG. 1 is a plot illustrating the lowered COF at 200° F. for a water-based drilling mud composition that includes both polyalphaolefin-2 (PAO-2) and graphene relative to compositions that do not include one or both of PAO-2 or graphene.

FIG. 2 is a plot illustrating the lowered COF at 200° F. for a water-based drilling mud composition that includes a mixed C10-C12 dimer, graphene, asphalt sulfonate salt, surfactant, and suspension agent. The mixed C10-C12 dimer is a mixed decene/dodecene (Synfluid® Mixed Dimer).

FIG. 3 is a plot illustrating the lowered COF with increasing temperature for a water-based drilling mud composition that includes both PAO-2 and graphene. The data indicates that the synergy between the PAO-2 and graphene can be activated with temperature.

FIG. 4 is a plot illustrating the lowered COF for a water-based drilling mud composition that includes PAO-2 and graphene relative to a water-based drilling mud composition that includes only graphene.

FIG. 5 is a plot illustrating the COF for water-based drilling mud compositions that include 1 wt % of a blend comprising 65 wt % of base mud of Table 1, or PAO-2, or mixed dimer (C10-C12), or C14 reactor wash, or Qatar GTL QHVI 3, or tall oil fatty acid with 15 wt % graphene, 15 wt % sodium asphalt sulfonate (SAS), 3 wt % surfactant (a C12-C15 linear alcohol ethoxylate), and 2 wt % polymer (a styrene-ethylene/propylene-styrene (SEPS) polymer). The Stribeck test was performed at 200° F.

FIG. 6 is a bar chart illustrating the average COF for a water-based drilling mud compositions that include 1 wt % of a blend comprising 65 wt % of base mud of Table 1, or PAO-2, or mixed dimer (C10-C12), or C14 reactor wash, or Qatar GTL QHVI 3, or tall oil fatty acid with 15 wt % graphene, 15 wt % SAS, 3 wt % surfactant, and 2 wt % polymer. The Stribeck test was performed at 200° F.

FIG. 7 is a plot illustrating the COF for water-based drilling mud compositions that include 3 wt % of a blend comprising 65 wt % of base mud of Table 1, or PAO-2, or mixed dimer (C10-C12), or C14 reactor wash, or Qatar GTL QHVI 3, or tall oil fatty acid with 15 wt % graphene, 15 wt % SAS, 3 wt % surfactant, and 2 wt % polymer. The Stribeck test was performed at 200° F.

FIG. 8 is a bar chart illustrating the average COF for water-based drilling mud compositions that include 3 wt % of a blend comprising 65 wt % of base mud of Table 1, or PAO-2, or mixed dimer (C10-C12), or C14 reactor wash, or Qatar GTL QHVI 3, or tall oil fatty acid with 15 wt % graphene, 15 wt % SAS, 3 wt % surfactant, and 2 wt % polymer. The Stribeck test was performed at 200° F.

FIG. 9 is a plot illustrating Traction COF for water-based drilling mud compositions that include 1 wt % of a blend comprising 65 wt % of base mud of Table 1, or PAO-2, or mixed dimer (C10-C12), or C14 reactor wash, or Qatar GTL QHVI 3, or tall oil fatty acid with 15 wt % graphene, 15 wt % SAS, 3 wt % surfactant, and 2 wt % polymer. The Stribeck test was performed at 200° F.

FIG. 10 is a plot illustrating Traction COF for water-based drilling mud compositions that include 3 wt % of a blend comprising 65 wt % of base mud of Table 1, or PAO-2, or mixed dimer (C10-C12), or C14 reactor wash, or Qatar GTL QHVI 3, or tall oil fatty acid with 15 wt % graphene, 15 wt % SAS, 3 wt % surfactant, and 2 wt % polymer. The Stribeck test was performed at 200° F.

FIG. 11 is a plot illustrating Pin-On-Disk (POD) COF for water-based drilling mud compositions that include 1 wt % of a blend comprising 65 wt % of base mud of Table 1, or PAO-2, or mixed dimer (C10-C12), or C14 reactor wash, or Qatar GTL QHVI 3, or tall oil fatty acid with 15 wt % graphene, 15 wt % SAS, 3 wt % surfactant, and 2 wt % polymer.

FIG. 12 is a plot illustrating POD COF for water-based drilling mud compositions that include 3 wt % of a blend comprising 65 wt % of base mud of Table 1, or PAO-2, or mixed dimer (C10-C12), or C14 reactor wash, or Qatar GTL QHVI 3, or tall oil fatty acid with 15 wt % graphene, 15 wt % SAS, 3 wt % surfactant, and 2 wt % polymer.

FIG. 13 is a plot illustrating the COF of an example drilling mud composition described herein and conventional commercially available drilling mud compositions. The Stribeck test was performed at 150° F.

FIG. 14 is a plot illustrating COF versus measured depth of an example drilling mud composition described herein and conventional commercially available drilling mud composition.

FIG. 15 is a plot illustrating Traction COF for water-based drilling mud compositions described herein. The Traction COF test was performed at 100° F.

FIG. 16 is a plot illustrating the COF for water-based drilling mud compositions described herein. The Stribeck test was performed at 100° F.

FIG. 17 is a plot illustrating Traction COF for water-based drilling mud compositions described herein. The Traction COF test was performed at 150° F.

FIG. 18 is a plot illustrating the COF for water-based drilling mud compositions described herein. The Stribeck test was performed at 150° F.

FIG. 19 is a plot illustrating Traction COF for water-based drilling mud compositions described herein. The Traction COF test was performed at 200° F.

FIG. 20 is a plot illustrating the COF for water-based drilling mud compositions described herein. The Stribeck test was performed at 200° F.

FIG. 21 is a plot illustrating a timed run for water-based drilling mud compositions described herein.

FIG. 22 is plot illustrating POD COF for water-based drilling mud compositions described herein.

FIG. 23 is a plot illustrating Traction COF versus slide-to-roll ratio (also referred to as sliding to rotating ratio) of water-based drilling mud compositions described herein, where the aqueous carrier includes Bakken brine. The Traction COF test was performed at 200° F.

FIG. 24 is a plot illustrating COF versus rotational speed (also referred to herein as rotating speed) of water-based drilling mud compositions described herein, where the aqueous carrier includes Bakken brine. The Stribeck test was performed at 200° F.

FIG. 25 is a plot illustrating Traction COF versus slide-to-roll ratio of a water-based drilling mud composition described herein, where the aqueous carrier includes sodium chloride (NaCl) brine. The Traction COF test was performed at 200° F.

FIG. 26 is a plot illustrating COF versus rotational speed of a water-based drilling mud composition described herein, where the aqueous carrier includes sodium chloride (NaCl) brine. The Stribeck test was performed at 200° F.

FIG. 27 is a plot illustrating Traction COF versus slide-to-roll ratio of a water-based drilling mud composition described herein, where the aqueous carrier includes a bentonite water-based mud. The Traction COF test was performed at 200° F.

FIG. 28 is a plot illustrating COF versus rotational speed ratio of a water-based drilling mud composition described herein, where the aqueous carrier includes a bentonite water-based mud. The Stribeck test was performed at 200° F.

To facilitate understanding, identical reference numerals have been used, where possible, to designate identical elements that are common to the figures. It is contemplated that elements and features of one aspect can be beneficially incorporated in other aspects without further recitation.

### DETAILED DESCRIPTION

Aspects of the present disclosure generally relate to new drilling compositions and uses thereof. A “composition” can include component(s) of the composition, reaction product(s) of two or more components of the composition, a remainder balance of remaining starting component(s), or combinations thereof. Unlike conventional water-based drilling mud compositions that suffer from low lubricity, the inventors found water-based drilling mud compositions that have excellent lubricity and low COF. Accordingly, and relative to conventional technologies, use of compositions described herein can provide better management and reduction of frictional forces between the formation or wellbore and drilling equipment (e.g., drill string). That is, use of compositions described herein provide better management of friction to avoid excessive torque and drag on drilling equipment. Drilling mud is interchangeably referred to herein as a drilling fluid.

Drilling mud compositions of the present disclosure can be utilized for any suitable application. For example, drilling mud compositions described herein can be used as a drilling fluid, or as a coiled-tubing fluid, or as a wellbore fluid, or as a kill mud composition, or as a completion fluid, or combinations thereof.

The increasing complexity of unconventional reservoirs marked by longer laterals and increasingly complex wellbore trajectories, and a focus on capital discipline demands innovative approaches to drilling fluid additives. Friction and mechanical wear remain persistent challenges in shale plays, directly affecting torque, drag, rate of penetration, and drill string life. New drilling fluid additives should provide increased efficiency in completing oil and gas wells, while also providing additional value. To address this challenge, and in some aspects, a novel tri-phase lubricant (as an example drilling mud composition of the present disclosure) was developed incorporating micronized graphene and engineered chemical components (for example, surface-active agents and a high-efficiency lubricant) into a liquid lubricant. The combination of these components, for example, asphalt sulfonate salt particles, graphene particles, and a base oil, can create a durable tribofilm on the surface of the drill pipe while filling asperities on metal surfaces. The combination of these components can promote formation of a durable tribofilm while filling asperities on metal surfaces. The durable tribofilm and asperity filling quality of the lubricant can enhance boundary and hydrodynamic lubrication and wear resistance under, for example, high-load conditions. The combination of the components can enable aspects of the present disclosure to be useful across boundary, mixed, and hydrodynamic lubrication regimes. The formulation can promote robust tribofilm development, enhance metal surface protection, and/or maintain compatibility with water-based drilling fluid systems.

Comprehensive laboratory evaluations were conducted using tribological methods to quantify the lubricant's performance, demonstrating substantial friction and wear reduction under high load and high temperature conditions. Testing in Bakken brine also confirmed substantial reductions in both coefficient of friction and wear factor compared to conventional lubricants. Field trials in the Bakken Basin validated these results through measurable improvements in drilling efficiency, reduced pipe wear, and lower operating costs. Here, for example, the field trial demonstrated the lubricant's ability to increase the rate of penetration and to reduce torque, while also showing a marked reduction in wear on the drill pipe and the bottom hole assembly. These improvements can reduce banding requirements at the end of the well, leading to lower operational costs and reduced environmental impact. Supporting laboratory studies based on Tribology, the science of friction, lubrication, and wear, were utilized to quantify the lubricant's performance. These tests confirmed that the lubricant reduced the coefficient of friction and wear factor in Bakken brine. Together, the field and laboratory data demonstrate the potential of this lubricant to improve drilling efficiency, extend equipment life, and reduce costs in, for example, unconventional shale applications and/or demanding shale environments.

In drilling operations, tribological behavior governs torque and drag, weight transfer, differential sticking risk, and mechanical wear. Effective drilling fluid lubricants should perform across the three fundamental lubrication regimes: boundary lubrication, mixed lubrication, and hydrodynamic lubrication. Downhole conditions are typically dominated by boundary and mixed lubrication, where fluid films are thin, surface contact is significant, and lubricant performance is governed not only by bulk fluid properties but also by surface chemistry and tribofilm formation. Components of lubricants described herein can aid in the transition through each lubrication regime (boundary, mixed, and hydrodynamic lubrication regimes) and can enhance drilling performance in extended reach or highly deviated wells.

During evaluation measurements, and compared to commercially available lubricants, aspects described herein achieved a significant reduction in the coefficient of friction and wear on laboratory machinery and enabled the creation of tribofilm. These findings were validated when applied in the field, with use of the composition showing a positive economic impact by reducing drill pipe wear, increasing rate of penetration, and maintaining stable rheological properties. These results underscore the critical role of tribology in the formulation of high-performance drilling fluid lubricants, marking a progressive shift toward more efficient and durable downhole operations.

The chemistry of the lubricant can play a role at low rotational speeds in the boundary lubrication regime (low rpm and high load), while the physics can dominate at low and high rotational speeds, when viscosity properties play a role. Solid only lubricants primarily work in the boundary lubrication regime. In contrast, aspects described herein can be characterized as solid liquid-like lubricants, which can combine the benefits of active solid in the boundary lubrication regime with the high-performance liquid lubricants in the hydrodynamic lubrication regime at high rpm (high speed). Both the chemistry in the boundary lubrication and physics in the hydrodynamic lubrication regime represent a synergy merger. Multi-phase lubricants described herein can combine the synergy between solid and liquid phases and synergy of active solids, which can further improve the boundary lubrication regime. In various examples, very low coefficient of friction values of 0.04 to 0.06 were obtained using aspects of the present disclosure, that cannot be achieved with traditional liquid or solid lubricants. These values of 0.04 to 0.06 are considered as ultra-low lubricity.

Drilling mud compositions of the present disclosure can be characterized as having one or more advantages over conventional drilling mud compositions.

For example, drilling mud compositions can be characterized as asperity filling. Asperity filling generally refers to how microscopic asperities (for example, voids) on a surface interact with, or are covered by, another material. In the context of drilling pipes, asperity influences friction and wear between, for example, the drill pipe and borehole wall, potentially leading to thread damage or stuck pipe due to increased friction, adhesion, or contact. Drilling mud compositions described herein overcome this issue because they are asperity filling. For example, it is believed that graphene particles, such as micronized graphene particles present in drilling mud compositions described herein fill microscopic surface asperities or voids in the surface of the drilling pipe. The tribofilm (a thin film formed on sliding surfaces) created by drilling mud compositions described herein seals the graphene in place on the pipe or other metallic surfaces, creating a smoother surface that in turn reduces friction and thread damage on the pipe under real-world conditions.

As another example, drilling mud compositions show significantly improved performance over conventional drilling mud compositions. In a field trial using drilling mud compositions described herein, a 2-mile lateral (horizontal) was completed in 5.75 days. For this field trial, after drilling down approximately 5,000 ft to 6,000 ft (1,520 m to 1,830 m) vertically, the drilling equipment transitioned to drill laterally (horizontally). Conventional technologies drill a 2-mile (3,220 m) lateral in 6.25 days. In contrast, drilling mud compositions described herein completed the 2-mile lateral (horizontal) in just 5.75 days, representing a reduction of 0.5 days or about 8%. This significant reduction in drilling time with the use of drilling mud compositions of the present disclosure represents significant cost savings. As drillers target laterals up to about 6-miles in length drilled in less time, compositions of the present disclosure solve these long-felt, but unsolved needs, by not only drilling longer laterals with reduced wear and torque on drilling equipment preventing maintenance and replacement, but also enabling faster drilling due to reduced frictional forces between metal surfaces and formation surfaces due to asperity filling of metallic voids and the formation of tribofilms over smoother surfaces.

As another example, aspects described herein also contemplate avoiding, or substantially avoiding, cheesing out and/or greasing out. Here, lubricants of the present disclosure (e.g., comprising asphalt sulfonate salt particles, graphene particles, and/or a base oil) can have excellent dispersibility in, for example, an aqueous carrier (e.g., water-based system or a brine-based system). Good dispersibility decreases the likelihood that lubricant particles will aggregate together and cease to be homogenized in the system. When aggregation occurs, a lubricant loses effectiveness by precipitating or coming out of solution and floating on top of the medium. In the industry, this phenomenon is referred to as “cheesing out”. That is, cheesing generally refers to the undesirable result where components of the lubricant separate from the carrier fluid and form a solid or semi-solid mass, resembling cheese, resulting in a reduction in the effective concentration of lubricant in the carrier fluid and damage to equipment. Most conventional lubricants will cheese out given enough time, particularly in the absence of agitation.

Stability is an indication of how long a lubricant stays dispersed in a fluid medium. A lubricant with good stability will not separate quickly from the medium after being dispersed. Better stability means a relatively longer time before the lubricant “cheeses out.” Aspects described herein can have good stability.

In some aspects, which can be combined with other aspects, lubricants described herein (e.g., comprising asphalt sulfonate salt particles, graphene particles, and/or a base oil) do not cheese out, or do not substantially cheese out, in aqueous carrier fluids, such as aqueous carrier fluids containing mono-, di-, and/or tri-valent ions. The lubricants described herein can avoid, or substantially avoid, formation of cheesing, in aqueous carrier fluids, such as aqueous carrier fluids containing mono-, di-, and/or tri-valent ions.

With respect to the greasing out phenomenon, produced water can have a very high concentration of salts, sometimes about 30% by weight. In such water, calcium mineral or water hardness is challenging to conventional drilling fluids as it tends to coagulate or flocculate organic components of a drilling fluid. Industry, however, desires to utilize produced water as at least a portion (for example, 10-20%) of the aqueous carrier for brine drilling muds instead of using fresh water. To be able to put heavy-brine water or produced water into use, an effective lubricant needs to be developed as the brine is quite abrasive to drill bits. However, calcium salts in heavy brine and produced water make it very difficult for conventional lubricants to be utilized due to the flocculation effect, also referred to as “greasing out”, especially at higher temperatures. In contrast, aspects of the present disclosure can avoid, or substantially avoid, greasing out.

In some aspects, which can be combined with other aspects, lubricants described herein (e.g., comprising asphalt sulfonate salt particles, graphene particles, and/or a base oil) do not grease out, or do not substantially grease out, in aqueous carrier fluids, such as aqueous carrier fluids containing mono-, di-, and/or tri-valent ions. The lubricants described herein can avoid, or substantially avoid, formation of greasing, in aqueous carrier fluids, such as aqueous carrier fluids containing mono-, di-, and/or tri-valent ions.

As another example, drilling mud compositions of the present disclosure can be characterized as better managing friction to avoid excessive torque and drag (and consequent wear) on drilling equipment relative to state-of-the-art drilling mud compositions. Here, for example, drilling mud compositions described herein show a greater reduction in frictional forces between the formation and drilling equipment. This reduced friction corresponds to less torque. As a result, and in use, drilling mud compositions of the present disclosure can enable quicker drilling and in less time, more pressure or force to reach the drill bit resulting in greater penetration into the reservoir/formation (e.g., enables drilling further distances in the lateral direction), reduced wear on equipment, or combinations thereof relative to conventional technologies.

As another example, use of drilling mud compositions of the present disclosure can significantly reduce the wear on drilling pipes. Wear on drilling pipes can be monitored in the field by visually inspecting and measuring pipe wear bands. When wear bands are worn down to below 1/32 of an inch (below 0.79 mm), a technician or operator must re-band the pipe by removing the worn band and welding a new band to the pipe. Wear bands must also be removed and replaced with a new band when defects such as voids, spalling, or excessive cracking occur. Wear bands must also be removed and replaced with a new band when an inspection reveals eccentric wear or uneven wear of the wear band. These inspections can be completed at the end of the well while laying down the pipe. In one example, use of drilling mud compositions described herein showed a 64% reduction in replacement of wear bands (corresponding to a reduction in drill pipe wear by 64%), even when drilling through unexpectedly tough rock, relative to other state-of-the-art drilling mud compositions. Here, even though directional drilling drilled through significantly tougher rock, compositions of the present disclosure facilitated completion of the well drilling with a post-run analysis revealing the significant 64% reduction in pipe wear.

Unlike conventional lubricants that rely on a single friction-reduction mechanism, lubricants described herein can include micronized graphene particles, sodium asphalt sulfonate (SAS), and a base oil in a stable, engineered dispersion that exhibits performance beyond the effects of its individual components. This synergistic interaction can provide COF values approaching super-lubricity levels (<0.1) under downhole temperature and load conditions where traditional water-based lubricants typically fail.

While not wishing to be bound by any theory, it is believed that the SAS can provide a strong surface affinity to metal and formation surfaces, promoting adsorption and boundary film formation. Graphene particles, which are traditionally difficult to deploy effectively in aqueous systems, can be stabilized within the formulation and can act as a low-shear, solid-state lubricating layer. The base oil can further enhance this interaction by reducing interlayer shear forces and facilitating the formation of a durable, low friction tribofilm. When combined, these components can form a self-assembling lubrication network that is activated under mechanical shear and elevated temperature, conditions typical of extended-reach and horizontal drilling. Laboratory testing conducted in accordance with ASTM G-99-23 demonstrated that the synergistic system can consistently reduce friction across boundary, mixed, and hydrodynamic lubrication regimes. In contrast to many conventional lubricants that degrade thermally, lubricants of the present disclosure can show improved performance with increasing temperature. This temperature-activated response can be advantageous in long laterals, where torque and drag typically escalate as bottom-hole temperatures increase. The lubricants described herein can also maintain compatibility with standard water-based drilling fluid chemistry, preserving rheology, emulsion stability, and solids suspension. Surprisingly, the solid-state micronized particles can function effectively within aqueous systems. By leveraging synergistic chemistry rather than single-component performance, lubricants of the present disclosure can deliver sustained friction reduction, improved drilling efficiency, and/or enhanced wellbore stability, addressing critical limitations of conventional water-based drilling fluids in modern shale and extended-reach applications.

Drilling mud compositions described herein can be used in wellbore drilling processes to form, for example, oil wells. In an aspect, SAS, an asphalt sulfonate salt, can be used to promote reduction of the COF. In addition, graphene and a base oil (such as PAO) can be dispersed in the composition to promote stability of the emulsion. It has been discovered that dispersed SAS particles can exhibit synergistic effects when combined with graphene and a base oil, for example, more than additive effects, and this combination can result in a COF value below 0.1, such as about 0.5 or less. As used herein, compositions characterized as having super-lubricity refer to compositions having a COF value of less than 0.1 as measured according to ASTM G-99-23. In contrast to the superior COF of compositions described herein, conventional water-based drilling mud compositions have COF values greater than 0.1.

While not wishing to be bound by any theory, it is believed that a chemical coupling or network formation can result by combining asphalt sulfonate salt particles, the base oil, and the graphene, thereby leading to the observed synergy. It is also believed that the insoluble PAO base oil can promote formation of a low-shear tribofilm due to the weak bonds of the PAO. The asphalt sulfonate salt polar molecules can be absorbed onto metal surfaces of drilling equipment and subsurface formation surfaces perpendicular to the metal surfaces. By utilizing Raman spectroscopy, it was found that the asphalt sulfonate salt polar molecules can form a comb-like tribofilm due to strong absorption onto metal. The graphene monolayer can form an envelope around the SAS particles, thereby forming an easily sheared layer, and the non-polar structure of the PAO can serve to enhance the absorption of the particles onto graphene.

While not wishing to be bound by any theory, besides filling asperities on drilling equipment, it is believed that the graphene particles can serve to reinforce lubricity under extreme pressure and temperature, such as those observed in the field. While not wishing to be bound by any theory, it is believed that the asphalt sulfonate salt particles can facilitate emulsion of the graphene particles into the drilling fluid and can facilitate or serve to lock the graphene in place for sustained reduction in wear on the drill pipe.

Lubrication performance in water-based drilling fluids remains a limiting factor for wear, torque, and drag. Conventional lubricants often lose stability in high-salinity, high-hardness, and/or variable-pH environments, limiting their effectiveness to reach measured depth and to prevent excessive wear. Aspects described herein present, for example, a technical development utilizing tribology, the study of friction and wear, and performance evaluation of a multi-phase micronized lubricant engineered to deliver durable tribological protection across multiple water-based drilling fluid systems. In some examples, the lubricant (a drilling mud composition described herein) can include a hybrid architecture of solid, liquid, and reactive chemical phases that interact under shear to form a stable tribofilm on metallic surfaces. Chemical reactivity can include sulfur reacting with metal surfaces, for example, sulfur can bond to metals perpendicularly in an advantageous configuration, to facilitate formation of the tribofilm. For example, the micronized graphene particles and the chemistry of one or more components present in the lubricant can facilitate formation of a protective tribofilm under shear, thereby minimizing metal-to-metal contact between, for example, a drill string, a bottom hole assembly (BHA), and a casing. The lubricant can be characterized as a self-forming tribofilm serving as a wear and friction reducer. For example, the tribofilm can serve to significantly lower the coefficient of friction and serve to mitigate wear in harsh drilling environments, extending the service life of equipment such as BHAs and drill strings. The lubricant can be described as a self-replenishing film that can minimize friction and wear in harsh environments, such as produced water, monovalent brines, divalent brines, and/or high-hardness systems. By, for example, minimizing wear-related failures and tripping frequency, aspects described herein can help reduce nonproductive time (for example, down time), operational expenses, and combinations thereof. Tripping frequency refers to how often downhole equipment such as the drill string or BHA is pulled out of the formation and replaced. Laboratory studies demonstrated that aspects of the present disclosure show consistent lubricity, surface protection, film integrity, and/or chemical performance over a range of pH values (varying alkalinity levels), for example, over a range from about 3 to about 12, such as from about 4 to about 11.8 or in a range from 6 to 12.

Comprehensive testing, including a tribometer (a tool to measure the profiles of the coefficient of friction) and lubricity evaluation monitor, wear scar analysis, and scanning electron microscopy confirmed reduction of coefficient of friction and wear by drilling mud compositions described herein. In some examples, the tribofilm can exhibit strong adhesion and chemical stability under thermal and salinity stress, validating its compatibility with diverse water-based drilling fluids such as fresh water, sea water, monovalent brines, divalent brines, produced brines, high-hardness water-based drilling fluids. Successful field trials further confirmed and validated the tribological design approach and scalability of example lubricants described herein. The material design, tribological mechanism, and performance validation of example lubricants described herein provide evidence that the multiphase micronized lubricants can significantly extend the operational range of water-based drilling fluids and reduce overall wear in drilling operations, highlighting a practical route toward environmentally compatible, high-performance lubrication.

In contrast to conventional lubricants, drilling mud compositions described herein can reduce friction without increasing (or without substantially increasing) mud viscosity. In further contrast to conventional lubricants, drilling mud compositions described herein can reduce friction without altering (or without substantially altering) rheological properties of the mud. Drilling mud compositions of the present disclosure can show improved fluid loss control relative to conventional compositions. For example, drilling mud compositions described herein can help contribute to reduced fluid loss through, for example, surface sealing at the wellbore-filter cake interface, while maintaining flowability and pumpability.

Drilling mud compositions described herein can be characterized as a multiphase lubricant designed utilizing tribology to form a self-replenishing tribofilm on metallic surfaces, providing long-lasting wear protection and friction reduction for any suitable water-based drilling fluids (water-based muds, WBM). Drilling mud compositions of the present disclosure can be formulated with micronized graphene and reactive chemistry to, for example, create a durable, low-shear boundary film that adapts dynamically to drilling conditions without altering (or without substantially altering) the base rheology of the mud system.

These, and other, effects can result in the excellent properties of the drilling mud compositions described herein. Such properties can include higher stability, improved lubricity, lower fluid loss, better equipment protection (improved wear reduction), better sealing of shale micro-fractures, and/or better formation stability relative to conventional drilling mud compositions. Drilling mud compositions of the present disclosure can also promote formation stability and removal of cuttings.

COF can be measured under different conditions. These measurements include Stribeck COF, traction COF, and pin-on-disk (POD) COF as provided in ASTM Designation G-99-23. Stribeck COF curve measurements are the standard configuration utilized for the tribometer. For Stribeck COF curve measurements, load, slide to rotating ratio (SSR), and temperature are set. The friction is then measured over a range of mean speeds, producing data in a Stribeck COF curve. This procedure can be repeated over a range of temperatures. During drilling operations, the drilling string starts rotating from a stationary position to an operating speed. In reference, a 5-inch drill pipe with a rotational speed of 150 rpm or 80 m/min is equivalent to 1,200 mm/s on the tribometer. The Stribeck curve analyzes the COF from 0 to 1,200 mm/s, providing analysis across the various lubrication regimes and characterizing the lubricant's performance. As used herein, the term “COF”, when used without the descriptors “traction” and “POD”, refers to the Stribeck COF unless specified to the contrary or the context clearly indicates otherwise.

For traction COF, traction test measurements are performed. Here, a rolling speed, load, and temperature are set. The slide to rotation ratio (SRR) is varied. This traction test produces a traction curve. This procedure can be repeated in a single test over a range of speeds, loads, and temperatures. This traction COF test allows one to correlate the COF when changing from sliding to rotation mode while drilling, also known as back-reaming with rotation.

For POD COF, POD COF test measurements are performed. Here, the upper ball specimen used in the Stribeck COF and traction COF measurement tests is replaced with a pin, and the ball shaft is locked in place. Such configuration allows the tribometer to operate with a pure sliding motion. This POD COF test simulates the variation of the COF versus time while pulling drill string or casing out the hole.

Aspects of the present disclosure generally relate to new drilling mud compositions. Drilling mud compositions described herein can include water-based drilling mud compositions and non-aqueous based (oil-based and synthetic-based) drilling mud compositions.

Drilling mud compositions of the present disclosure can include a carrier. The carrier can include an aqueous material (aqueous carrier) or oil-based material (oil-based carrier). Drilling mud compositions described herein can further include asphalt sulfonate salt particles, graphene particles, a base oil, or combinations thereof.

With respect to the aqueous carrier, any suitable aqueous carrier can be utilized such as water, distilled water, fresh water, ground water, brine, or combinations thereof. The brine can include a calcium chloride brine. The brine can include sea water, salt water, a monovalent brine, a divalent brine, production water generated from oil-gas exploration, a Permian Basin brine, a Bakken brine, or combinations thereof.

Drilling mud compositions described herein can further include an asphalt sulfonate. Asphalt sulfonate, also known as sulfonated asphalt, can be formed by sulfonating an asphalt with a sulfonation agent. Sulfonation agents can include fuming sulfuric acid, chlorosulfonic acid, concentrated sulfuric acid, sulfur trioxide, or combinations thereof. Asphalt sulfonate can be prepared by forming a mixture of asphalt and a solvent and exposing the mixture to sulfonation agent. The solvent can include hexane. After sulfonation, the resulting product can be neutralized to form a salt, followed by separation from the solvent. The neutralization can be performed using a basic compound, for example, sodium hydroxide or potassium hydroxide. Neutralization with sodium hydroxide forms sodium asphalt sulfonate. Neutralization with potassium hydroxide forms potassium asphalt sulfonate. Asphalt sulfonate can have different properties and include a mixture or combination of materials based on the parameters of the sulfonation process, for example, the degree of sulfonation or the type of sulfonating agent utilized.

Asphalt refers to hydrocarbon materials including bitumen components, for example, naphthene aromatics, polar aromatics, saturated hydrocarbons, asphaltenes, or combinations thereof. The asphalt sulfonate useful with aspects of the present disclosure can be derived from asphalt obtained from natural sources or can be obtained by refining petroleum by one or more of distillation, precipitation, cracking, oxidation, or other suitable operations. The asphalt can include one or more of asphaltenes, maltenes, blown asphalt, straight residual oils, distillation residues, still bottoms, cracking residues, asphaltic bitumens, or combinations thereof. Various high molecular weight species of asphalt are commonly separated into 4 fractions: saturates, aromatics, resins, and asphaltenes. The asphaltene fraction is determined by a gravimetric method and is defined to be the hexane insoluble fraction of asphalt. The other fractions are separated by column chromatography using a silica column packing and increasing the polarity of the solvent to elute the respective fractions. The asphaltene fraction is soluble in high polarity solvents such as toluene. Asphalts vary significantly in composition and physical properties depending on the crude oil source and the refinery process. The asphalt can be oxidized to increase the softening point. It is water insoluble.

The asphalt sulfonate useful with aspects of the present disclosure can be derived from natural asphalts such as Gilsonite® (American Gilsonite Company, Houston, Tex.), known generically as uintahite, asphaltum, or asphaltite. Natural asphalts are similar to petroleum asphalt and have similar properties. Gilsonite® can be used, for example, when it is desired to have an asphalt with a high softening point.

The asphalt sulfonate salt can include any suitable salt of asphalt sulfonate such as sodium asphalt sulfonate (SAS), potassium asphalt sulfonate, calcium asphalt sulfonate, lithium asphalt sulfonate, or combinations thereof, such as sodium asphalt sulfonate, potassium asphalt sulfonate, or combinations thereof. Unlike asphalt, which is neither anionic nor water soluble, sodium asphalt sulfonate can be anionic and water soluble, for example, at least 70%, or at least 80% water soluble. The asphalt sulfonate salt can be in the form of particles.

Sodium asphalt sulfonate can be produced by reacting asphalt (thinned with heptane) with sulfur trioxide to form the sulfonic acid. The acid can be neutralized with caustic (50% NaOH) to form the sodium salt. This product is water soluble and no longer exhibits the softening point or other characteristics of asphalt.

Suitable sodium asphalt sulfonate particles useful with aspects of the present disclosure can include those described in U.S. Pat. No. 9,328,280, which is incorporated herein by reference in its entirety. Suitable sodium asphalt sulfonate particles useful with aspects of the present disclosure can include Soltex® additive, Drill-Sure™ additive, or combinations thereof, each of which is commercially available from Drilling Specialties Company, The Woodlands, Texas. Sodium asphalt sulfonates do not exhibit the typical properties of asphalt, do not melt, and do not have a softening point, in contrast with asphalt and other natural bitumen products that do soften and melt.

Sodium asphalt sulfonate particles suitable for use with aspects of the present disclosure can be of any suitable shape. For example, the asphalt sulfonate particles can be cylindrical, discoidal, spherical, tabular, ellipsoidal, equant, irregular, or combinations thereof, among other shapes.

The sodium asphalt sulfonate particles can be characterized as having a particle size in a range from about 5 microns (μm) to about 100 μm, such as from about 10 μm to about 90 μm, such as from about 20 μm to about 80 μm, such as from about 30 μm to about 70 μm, such as from about 40 μm to about 60 μm.

The sodium asphalt sulfonate particles can be characterized as having a particle size distribution wherein the D50 is about 35 μm or less, such as about 30 μm or less, such as about 25 μm or less, such as about 20 μm or less, such as about 15 μm or less, or in a range from about 25 μm to about 35 μm, such as from about 27 μm to about 32 μm; and/or a D90 that can be about 215 μm or less, such as about 150 μm or less, such as about 100 μm or less, such as about 95 μm or less, such as about 90 μm or less, such as about 85 μm or less, such as about 80 μm or less, such as about 75 μm or less, or in a range from about 70 μm to about 96 μm, such as from about 75 μm to about 90 μm, such as from about 80 μm to about 85 μm. D50 refers to the median particle size. D90 refers to the cumulative undersize distribution which notes the percentage of particles (90%) having sizes at or below the indicated value. The D50 and D90 can be determined by standard particle size measurements such as physically sifting the material, measuring the mass of each fraction, and calculating that fraction as a percentage of the total.

Illustrative, but non-limiting, sodium asphalt sulfonate particles can be characterized as having a D50 of about 29 μm±8% measured using a Beckman Coulter particle size analyzer (Beckman Coulter LS 13 320 LS Particle Size Analyzer); and/or a D90 of about 83 μm±15% measured using a Beckman Coulter particle size analyzer (Beckman Coulter LS 13 320 LS Particle Size Analyzer).

Drilling mud compositions described herein can further include graphene. Graphene is a two-dimensional (2D) sheet of carbon organized into hexagonal honeycombs. Graphene is low-friction, has very high stiffness, and its thermal conductivity can reduce friction and wear. Any suitable graphene can be utilized. The graphene can include an allotrope of carbon that includes a single layer of atoms arranged in a hexagonal lattice nanostructure. The graphene can include few-layer graphene (FLG). FLG is defined by the International Organization for Standards (ISO) as being a 2D material having between 3 and 10 well-defined stacked graphene layers (ISO/TS 80004-13:2017). The graphene can include graphene nanoplatelet (GNP). GNP is a nanoplatelet made of graphene layers (ISO/TS 80004-13:2017). In some aspects, which can be combined with other aspects, the GNP can have a thickness of between 1 nm to 3 nm and lateral dimensions ranging from approximately 100 nm to 100 μm. The graphene can include bilayer graphene. Bilayer graphene is a two-dimensional material made of two well-defined stacked graphene layers (ISO/TS 80004-13:2017).

The graphene can be in the form of graphene particles. Graphene particles are interchangeably referred to herein as powdered graphene, graphene microparticles, or thin graphite. The graphene particles can have any suitable population-averaged particle size and particle size distribution. The population averaged particle size is a D50 size measured by laser diffraction. The graphene particles can have a population averaged particle size (D50) in a range from about 1 micron (μm) to about 100 μm, such as from about 5 μm to about 70 μm, such as from about 10 μm to about 50 μm, such as from about 20 μm to about 40 μm, or in a range from about 5 μm to about 50 μm, or in a range from about 10 μm to about 70 μm.

The graphene particles can include micronized graphene particles, nano-graphene particles, graphene nanoplatelets, thin graphite, graphite, or combinations thereof. Thin graphite can include graphite that is less than 150 layers, such as about 100 layers. For nano-graphene particles, one of the dimensions is nanosized while the other dimension is micron sized. The micronized graphene (or thin graphite) particles or agglomerates thereof can have a D50 in a range from about 26 μm to about 50 μm, such as from about 30 μm to about 46 μm, such as from about 34 μm to about 42 μm, such as about 38 μm. The nano-graphene particles can have a D50 in a range from about 1 μm to about 25 μm, such as from about 5 μm to about 21 μm, such as from about 9 μm to about 17 μm, such as about 13 μm. Any suitable graphene or thin graphite particle can be utilized such as those available from NanoXplore and sold under the tradename TriboGraf™ CP-X, which is interchangeably referred to herein as graphene. Graphene particles useful with aspects described herein can include TriboGraf™ CP-X.

Prior to or during use of the drilling mud compositions described herein, the graphene particles can serve to facilitate movement or sliding of the asphalt sulfonate salt particles over the base oil. Such action can contribute to the excellent COFs observed.

Drilling mud compositions described herein can further include a base oil. Any suitable base oil can be utilized. For example, the base oil can include a polyalphaolefin (PAO), a C8 dimer, a C8 trimer, a C10 dimer, a C12 dimer, a C12 trimer, a C14 dimer, mixed C10-C12 dimers, a tall oil fatty acid, a C14 hydrocarbon (C₁₄H₂₈), a gas-to-liquids (GTL) base oil, dodecene, dodecane, decane, decene, a monounsaturated fatty acid, or combinations thereof. The C14 hydrocarbon base oil can be interchangeably referred to herein as a C14 reactor wash.

PAOs are type IV base oils. PAOs can be produced through synthesizing oligomers of decene, dodecene, octene, or combinations thereof, such as 1-decene, 1-dodecene, 1-octene, or combinations thereof. These oligomers can be distilled and hydrogenated to yield specific molecular weight ranges that meet selected viscosity grades.

Tall oil fatty acid (TOFA) refers to an oil that includes fatty acids, rosin acids, and unsaponifiables. The TOFA can be a byproduct from the Kraft process of wood pulp manufacture. The TOFA can be crude or distilled.

The GTL base oil refers to a base oil derived from the Fischer-Tropsch process. An example GTL base oil useful with aspects of the present disclosure can include Qatar GTL QHVI 3 commercially available from Shell Oil Company. Qatar GTL QHVI 3 is a refined hydrocarbon base oil (C18-C50) having a kinematic viscosity (100° C.) of 2.69 mm²/s.

Mixed C10-C12 dimers refers to a mixture of dimers of C10, C11, and/or C12. A C10 dimer can include an unhydrogenated dimer (C₁₀H₂₀)₂. A C12 dimer can include an unhydrogenated dimer (C₁₂H₂₄)₂. Mixed C10-C12 dimers are commercially available from Chevron Phillips Chemical Company LP under the tradename Synfluid® Mixed Dimer. C8, C10, C12, and C14 dimers can include unhydrogenated dimers and/or hydrogenated dimers. C8, C12 trimers can include unhydrogenated trimers and/or hydrogenated trimers.

Monounsaturated fatty acids include one olefin (a carbon-carbon double bond) in the fatty acid chain. Any suitable monounsaturated fatty acid can be utilized such as, for example, oleic acid.

The base oil can have any suitable kinematic viscosity at 100° C. The kinematic viscosity (at 100° C.) of the base oil can be about 10 centistokes (cSt) or less, such as in a range from about 1 cSt to about 10 cSt, such as from about 2 cSt to about 9 cSt, such as from about 3 cSt to about 8 cSt, such as from about 4 cSt to about 7 cSt, such as from about 5 cSt to about 6 cSt, or from about 1 cSt to about 7 cSt, such as from about 1.5 cSt to about 6 cSt. The kinematic viscosity (at 100° C.) is measured according to ASTM D445.

The base oil can include a PAO derived from a C10-C12 alpha-olefin. Additionally, or alternatively, the base oil can include a PAO derived from decene, such as 1-decene. For example, the PAO can include a hydrogenated dimer of decene, such as a hydrogenated dimer of 1-decene, for example, PAO-2. PAO-2 is a PAO that has a kinematic viscosity (at 100° C.) in a range from about 1.7 cSt to about 2.2 cSt. PAO-2 is commercially available from Chevron Phillips Chemical Company LP under the tradename Synfluid® PAO-2. Additionally, or alternatively, the base oil can include a PAO derived from 1-dodecene. For example, the PAO can include a hydrogenated dimer of 1-dodecene, such as a hydrogenated trimer of 1-dodecene. Combinations of PAOs can be utilized in suitable proportions.

The base oils, such as polyalphaolefins, can show compatibility with high and low pH environments, can show compatibility with various brines and production water, and can enhance low-temperature performance and shear stability.

Prior to, or during use, of the drilling mud compositions described herein, the base oil can serve to reduce shear stress between two or more layers of the graphene particles. Additionally, or alternatively, the base oil can serve to facilitate sliding, movement, or a combination thereof between two or more layers of the graphene particles. Additionally, or alternatively, the base oil can serve to promote stabilization of the drilling mud compositions by stabilizing an interface between the asphalt sulfonate salt particles and the graphene particles of the composition. One or more of such actions can contribute to the superior COFs observed.

Drilling mud compositions described herein can include one or more additional materials. Such one or more additional materials are optional and can include a suspending agent, a surfactant, an antifoam additive, or combinations thereof.

Suspending agents can be used to help keep particles present in drilling mud compositions suspended or dispersed throughout the drilling mud composition. Suitable suspending agents can include styrene-containing polymers, such as styrenic thermoplastic block copolymers. Styrene block copolymers can include styrene-ethylene/butylene-styrene (SEBS), styrene-ethylene/propylene-styrene (SEPS), derivatives thereof, or combinations thereof. The SEBS, SEPS, or both, can have a hydrogenated midblock.

Surfactants can be used for, e.g., emulsification of the drilling mud composition, wetting of formation surfaces, or combinations thereof. Suitable surfactants can include a non-ionic surfactant such as C12-C15 linear alcohol ethoxylate (Bio-Soft® N25-12) or non-ionic ethoxylated sulfur compound (Aqua-Cleen® HC, commercially available from Chemical Products Industries).

Drilling mud compositions described herein can include any suitable antifoam additive. For example, an antifoam additive can be useful when the base oil includes a monounsaturated fatty acid such as oleic acid, though antifoam additives can be used to achieve other characteristics where desired.

Drilling mud compositions described herein can further include any suitable solid-state lubricant. Suitable solid-lubricants can include Tribex™ ERD commercially available from Drilling Specialties Company, The Woodlands, Texas.

Drilling mud compositions of the present disclosure can further include other suitable additional materials, for example, clay, a mineral, a xanthan gum, a polyanionic cellulose polymer, or a combination thereof. A suitable clay includes bentonite, and a suitable minerals include barite, calcium carbonate, or combinations thereof. A suitable xanthan gum material includes Flowzan® biopolymer. Flowzan® biopolymer is a xanthan gum biopolymer commercially available from Drilling Specialties Company, The Woodlands, Texas. A suitable polyanionic cellulose polymer includes Drispac® Superlo®, commercially available from Drilling Specialties Company, The Woodlands, Texas. Other suitable additional materials can be utilized.

Drilling mud compositions of the present disclosure can include any suitable amount of the various components. For example, a drilling mud composition can include an amount (by mass) of the base oil that is greater than or equal to the amount of the asphalt sulfonate salt particles. Additionally, or alternatively, a drilling mud composition can include an amount (by mass) of the base oil that is greater than or equal to the amount of the graphene particles. Additionally, or alternatively, a drilling mud composition can include an amount (by mass) of the asphalt sulfonate salt particles that is greater than or equal to an amount of the graphene particles. Additionally, or alternatively, a drilling mud composition can include an amount (by mass) of the graphene particles that is greater than or equal to an amount of the asphalt sulfonate salt particles.

In some aspects, which can be combined with other aspects, a water-based drilling mud composition can include:
(a) an aqueous carrier; and
(b) a mixture that includes a base oil, asphalt sulfonate salt particles, graphene particles, and optionally one or more additional materials.

The mixture can be a blend or a suspension of these components. The one or more additional materials optionally present in the mixture (b) can include, for example, a suspending agent, a surfactant, or combination thereof.

An amount of the aqueous carrier (a) in the water-based drilling mud composition can be in a range from about 40 wt % to about 99.9 wt %, such as from about 95 wt % to about 99.5 wt %, such as from about 95 wt % to about 99 wt %, such as from about 96 wt % to about 98 wt %, such as about 97 wt %, or from about 96 wt % to about 97 wt %, or from about 97 wt % to about 98 wt %, or about 96 wt %, or about 97 wt %, or about 98 wt % based on a total weight of the water-based drilling mud composition.

An amount of the mixture (b), e.g., blend or suspension, in the water-based drilling mud composition can be in a range from about 0.1 wt % to about 5 wt %, such as from about 0.5 wt % to about 5 wt %, such as from about 1 wt % to about 5 wt %, such as from about 2 wt % to about 4 wt %, such as about 3 wt %, or from about 3 wt % to about 4 wt %, or from about 2 wt % to about 3 wt %, or about 2 wt %, or about 3 wt %, or about 4 wt % based on the total weight of the water-based drilling mud composition.

Any suitable amount of base oil can be present in the mixture (b) of the water-based drilling mud composition. For example, an amount of the base oil in the mixture (b) can be in a range from about 60 wt % to about 70 wt %, such as from about 61 wt % to about 69 wt %, such as from about 62 wt % to about 68 wt %, such as from about 63 wt % to about 67 wt %, such as from about 64 wt % to about 66 wt %, such as about 65 wt % based on a total weight of the mixture (b). The total weight of the mixture (b) is equal to 100 wt %. The total weight of the mixture (b) is based on the combined weight of the base oil, the asphalt sulfonate salt particles, the graphene particles, and the optional one or more additional materials.

Any suitable amount of asphalt sulfonate salt particles can be present in the mixture (b) of the water-based drilling mud composition. For example, an amount of the asphalt sulfonate salt particles in the mixture (b) can be in a range from greater than 0 wt % to about 25 wt %, such as from about 1 wt % to about 25 wt %, such as from about 5 wt % to about 25 wt %, such as from about 8 wt % to about 22 wt %, such as from about 11 wt % to about 19 wt %, such as from about 13 wt % to about 17 wt %, such as from about 14 wt % to about 16 wt %, such as about 15 wt % based on the total weight of the mixture (b).

Any suitable amount of graphene particles can be present in the mixture (b) of the water-based drilling mud composition. For example, an amount of the graphene particles in the mixture (b) can be in a range from greater than 0 wt % to about 25%, such as from about 1 wt % to about 25 wt %, such as from about 5 wt % to about 25 wt %, such as from about 8 wt % to about 22 wt %, such as from about 11 wt % to about 19 wt %, such as from about 13 wt % to about 17 wt %, such as from about 14 wt % to about 16 wt %, such as about 15 wt % based on the total weight of the mixture (b).

When the mixture (b) includes the suspending agent, an amount of the suspending agent in the mixture (b) can be in a range from greater than 0 wt % to about 15 wt %, such as from about 1 wt % to about 15 wt %, such as from about 4 wt % to about 12 wt %, such as from about 7 wt % to about 9 wt %, such as about 9 wt %, or in a range from about 0.5 wt % to about 5 wt %, such as from about 1 wt % to about 4 wt %, such as from about 2 wt % to about 3 wt %, such as about 2 wt % based on a total weight of the mixture (b).

When the mixture (b) includes the surfactant, an amount of the surfactant in the mixture (b) can be in a range from greater than 0 wt % to about 6 wt %, such as from about 0.5 wt % to about 5.5 wt %, such as from about 1 wt % to about 5 wt %, such as from about 2 wt % to about 4 wt %, such as about 3 wt % based on a total weight of the mixture (b).

In some aspects, which can be combined with other aspects, a water-based drilling mud composition can include:
an amount of the aqueous carrier that can be about 90 vol % or more, such as about 92 vol % or more, such as about 94 vol % or more, such as about 96 vol % or more, such as about 97 vol % or more, such as about 98 vol % or more, such as about 99 vol % or more of the aqueous carrier based on a total vol % of the aqueous carrier (a) and the mixture that includes a base oil, asphalt sulfonate salt particles, graphene particles, and optionally one or more additional materials (b), and the total vol % of the aqueous carrier (a) and the mixture (b) is equal to 100 vol %; and
an amount of the mixture that includes a base oil, asphalt sulfonate salt particles, graphene particles, and optionally one or more additional materials (b) can be greater than 0 vol % and about 10 vol % or less, such as about 8 vol % or less, such as 6 vol % or less, such as about 4 vol % or less, such as about 3 vol % or less, such as about 2 vol % or less, such as about 1 vol % or less based on the total vol % of the aqueous carrier (a) and the mixture (b).

A concentration of asphalt sulfonate salt particles in drilling mud compositions described herein can be in a range from about 15 pounds per barrel (lbm/bbl) to about 25 lbm/bbl, such as from about 17 lbm/bbl to about 23 lbm/bbl, such as from about 19 lbm/bbl to about 21 lbm/bbl, such as about 20 lbm/bbl.

In some aspects, which can be combined with other aspects, a concentration of graphene particles in drilling mud compositions described herein can be equal to that of the concentration of asphalt sulfonate salt particles. In some aspects, which can be combined with other aspects, a concentration of graphene particles in drilling mud compositions described herein can be about 15 lbm/bbl or less, such as in a range from about 1 lbm/bbl to about 15 lbm/bbl, such as from about 5 lbm/bbl to about 15 lbm/bbl, such as from about 7 lbm/bbl to about 13 lbm/bbl, such as from about 9 lbm/bbl to about 11 lbm/bbl, such as about 10 lbm/bbl of the water-based drilling mud composition.

Water-based drilling mud compositions of the present disclosure can be in the form of an emulsion such as an oil-in-water emulsion. The emulsion can include the aqueous carrier, an oil phase that includes a base oil (for example, PAO, decene, octene, or combinations thereof) dispersed as droplets in the aqueous carrier, asphalt sulfonate salt particles, and graphene particles, and optionally a water-in-oil emulsifier. In various aspects of the present disclosure, the insoluble asphalt sulfonate salt particles and/or graphene particles can be present at an oil-water interface between the oil phase and the aqueous phase of the drilling mud composition. For example, the insoluble asphalt sulfonate salt particles and/or graphene particles can promote stabilization of an emulsion formed in response to introduction of an oil phase in the composition.

Drilling mud compositions described herein can have a lower COF than a composition without one or more of the asphalt sulfonate salt particles, the base oil, or the graphene particles. Drilling mud compositions described herein can be characterized as having super-lubricity (for example, a COF less than 0.1).

Graphene is a solid lubricant, yet drilling fluids involve the use of fluids. Forming stable dispersions of solid lubricants has proven difficult by conventional technologies. This is particularly true for graphene in the presence of water. For example, graphene shows super-lubricity at a range of loads and sliding rates at low relative humidity conditions. Yet, once relative humidity increases to 30% or more, the COF increases to values outside of the super-lubricity regime. However, as described herein, the inventors found a synergy between graphene particles with one or more of asphalt sulfonate salt particles (for example, SAS particles) and/or a base oil (for example, PAO). The synergy can allow the solid graphene particles to, for example, serve as a lubricant in the presence of water. The synergy can also, for example, provide a low COF in the presence of water. The synergy can also enable asperity filling wherein appropriately sized graphene particles can fill in similarly sized voids on metal surfaces, producing a smoother surface, while asphalt sulfonate salt particles and/or a base oil can enable the formation of a tribofilm to hold in place asperity-filling graphene particles on metal surfaces.

COF measurements of compositions described herein were made according to ASTM Designation G-99-23 as described in the Examples section. The COF values reported herein are unitless. As described, the COF are measured in the range of the rotating speeds but also an average COF can be calculated. The rotating speeds are correlated to the rotating speed of the rotary assembly in real conditions.

Drilling mud compositions described herein can have a COF (measured at 200° F. and at a rotating speed of 1-1,200 mm/s according to ASTM Designation G-99-23) of less than 0.1, such as in a range from about 0.01 to about 0.09, such as from about 0.02 to about 0.08, such as from about 0.03 to about 0.07, such as from about 0.04 to about 0.06, such as from about 0.046 to about 0.048, or from about 0.026 to about 0.068, such as from about 0.027 to about 0.061, such as from about 0.031 to about 0.048, or about 0.05 or less, such as in a range from about 0.03 to about 0.05, such as from about 0.04 to about 0.05. These COF values of the water-based drilling mud composition can be an average over the range of rotating speeds or can be measured at a single rotating speed.

Drilling mud compositions described herein can have a COF (measured at 150° F. and at a rotating speed of 1-1,200 mm/s) of less than 0.1, such as in a range from about 0.037 to about 0.078, such as from about 0.044 to about 0.071, such as from about 0.051 to about 0.064, such as from about 0.054 to about 0.061. These COF values of the water-based drilling mud composition can be an average over the range of rotating speeds or can be measured at a single rotating speed.

Drilling mud compositions described herein can have a COF (measured at 100° F. and at a rotating speed of 1-1,200 mm/s) of less than 0.1, such as in a range from about 0.044 to about 0.087, such as from about 0.05 to about 0.08, such as from about 0.058 to about 0.074, such as from about 0.064 to about 0.067. These COF values of the water-based drilling mud composition can be an average over the range of rotating speeds or can be measured at a single rotating speed.

At a temperature of 200° F. and at a rotating speed of 1.4 mm/s, drilling mud compositions described herein can have a COF of about 0.09 or less, about 0.08 or less, about 0.07 or less, about 0.06 or less, about 0.055 or less, or about 0.052 or less.

At a temperature of 200° F. and at a rotating speed of 6.5 mm/s, drilling mud compositions described herein can have a COF of about 0.09 or less, about 0.08 or less, about 0.07 or less, about 0.06 or less, about 0.05 or less, about 0.045 or less, or about 0.043 or less.

At a temperature of 200° F. and at a rotating speed of 21 mm/s, drilling mud compositions described herein can have a COF of about 0.07 or less, about 0.06 or less, about 0.05 or less, or about 0.045 or less.

At a temperature of 200° F. and at a rotating speed of 34 mm/s, drilling mud compositions described herein can have a COF of about 0.08 or less, about 0.07 or less, about 0.06 or less, about 0.05 or less, or about 0.046 or less.

At a temperature of 200° F. and at a rotating speed of 70 mm/s, drilling mud compositions described herein can have a COF of about 0.09 or less, such as about 0.08 or less, about 0.07 or less, about 0.06 or less, about 0.056 or less, about 0.05 or less, about 0.045 or less, about 0.04 or less, or about 0.035 or less.

At a temperature of 200° F. and at a rotating speed of 112 mm/s, drilling mud compositions described herein can have a COF of about 0.09 or less, about 0.08 or less, about 0.07 or less, about 0.06 or less, about 0.056 or less, about 0.05 or less, about 0.045 or less, about 0.04 or less, or about 0.039 or less.

Drilling mud compositions of the present disclosure can be characterized as having super-lubricity in a boundary lubrication regime (for example, at low rotating speeds in a range from greater than 0 mm/s to about 100 mm/s). Here, when the drill bit begins rotating at low revolutions per minute (rpm) downhole, such as in horizontal holes, the bottom hole assembly and the wellbore or casing are in contact. When the bottom hole assembly and the wellbore or casing are in contact, the COF is high which is reflected in high torque. In such a scenario, reduction of the COF can be important and water-based drilling mud compositions described herein can be used to reduce the COF (and torque) under such scenarios.

Various components present in drilling mud compositions described herein can contribute to the excellent COF values observed. For example, at least a portion of the asphalt sulfonate salt particles, such as SAS particles, can aggregate or cluster, thereby having minimal surface area to contact one or more other components present in the drilling mud composition. While not wishing to be bound by any theory, it is believed that two or more layers of the asphalt sulfonate salt particles can form scrolls, thereby reducing a contact area between the asphalt sulfonate salt particles and one or more other components of the drilling mud composition. Such scroll formation of the asphalt sulfonate salt particles can occur prior to, or during, use of the water-based drilling mud composition in a formation. It is also believed that two or more layers of graphene particles present in drilling mud compositions described herein can form scrolls (for example, nanoscrolls), thereby reducing a contact area between the graphene particles and one or more other components of the water-based drilling mud composition. Such scroll formation of the graphene particles can occur prior to, or during, use of the water-based drilling mud composition in a formation. It is also believed that two or more layers of graphene particles present in drilling mud compositions described herein can form an envelope around the asphalt sulfonate salt particles sliding over a film of the base oil. Such envelope formation can occur prior to, or during, use of the water-based drilling mud composition in a formation. One or more of these effects can contribute to the super-lubricity observed at the macro-micro level.

Drilling mud compositions described herein can have a COF that decreases with increasing temperature from 100° F. to 200° F. For example, the COF can be from about 0.065 to about 0.069 at 100° F., from about 0.059 to about 0.063 at 150° F., and from about 0.046 to about 0.050 at 200° F. As another example, the COF can be from about 0.062 to about 0.066 at 100° F., from about 0.052 to about 0.056 at 150° F., and from about 0.044 to about 0.048 at 200° F.

Drilling mud compositions of the present disclosure can have a lower COF than a drilling mud composition that does not include one or more of the graphene particles, the asphalt sulfonate salt particles, or the base oil. For example, drilling mud compositions of the present disclosure can have a COF, measured at 100° F., that is at least 5% less or at least 10% less, or at least 15% less, or at least 20% less, or at least 22% less, or at least 25% less than a COF of the drilling mud composition without the graphene particles. Additionally, or alternatively, drilling mud compositions of the present disclosure can have a COF, measured at 150° F., that is at least 5% less, or at least 7.5% less, or at least 10% less, or at least 15% less, or at least 18% less than the COF of the drilling mud composition without the graphene particles. Additionally, or alternatively, drilling mud compositions of the present disclosure can have a COF, measured at 200° F., that is at least 5% less, or at least 10% less, or at least 15% less, or at least 20% less, or at least 22% less, or at least 25% less, or at least 26% less, or at least 29% less than the COF of the water-based drilling mud composition without the graphene particles.

In some aspects, which can be combined with other aspects, a drilling mud composition described herein can have a COF, measured at 100° F., of about 0.1 or less (versus 0.23 for a control); a COF, measured at 150° F., of about 0.06 or less (vs 0.27 for control); a COF, measured at 200° F., of about 0.04 or less (vs 0.35 for control); or combinations thereof. The control is a base mud composition (“base”) as described in the Example 3. The drilling mud composition can include graphene particles. The drilling mud composition can further include asphalt sulfonate salt particles. The drilling mud composition can further include a base oil. The drilling mud composition can further include an aqueous carrier or an oil-based material, the oil-based material different from the base oil. The reduction in COF can be a result of using the graphene particles as well as the synergistic effect of two or more of the graphene particles, the asphalt sulfonate salt particles, and the base oil.

Aspects of the present disclosure also relate to oil-based drilling mud compositions. Oil-based drilling compositions include an oil-based material (an oil-based carrier). The oil-based material can include diesel oil, mineral oil, synthetic oil, or combinations thereof.

The oil-based drilling composition can further include graphene particles described herein, asphalt sulfonate salt particles described herein, a base oil described herein, or combinations thereof. The base oil of the oil-based drilling mud composition is different from the oil-based material of the oil-based drilling mud composition. The oil-based drilling mud composition can further include one or more additional materials such as a suspending agent, a surfactant, or combinations thereof.

Amounts and concentrations of the various components, for example, graphene particles, asphalt sulfonate salt particles, and one or more optional additional materials, in the oil-based drilling composition can be the same or similar to that described above for the water-based drilling mud composition. The amounts and concentrations of the oil-based material (or oil-based carrier) used for the oil-based drilling composition can be the same or similar to those amounts and concentrations described herein for the aqueous carrier of the water-based drilling mud composition.

Aspects of the present disclosure also generally relate to methods of making drilling mud compositions described herein. Water-based drilling mud compositions (for example, oil-in-water emulsions) described herein can be formed according to any suitable techniques. A technique includes emulsifying a precursor composition to form a water-based drilling mud composition described herein. The precursor composition can include an aqueous carrier, asphalt sulfonate salt particles, and graphene particles. One or more optional additional materials such as a suspending agent, surfactant, or both, can form a portion of the precursor composition.

The emulsifying can include subjecting the precursor composition to a high shear in a wellbore formation or in a mixer. For example, the precursor composition can be sheared outside a formation and then introduced into the formation. Additionally, or alternatively, the precursor composition can be sheared within the formation, for example, by recirculation through a pump, a mixer, or a combination thereof. The emulsifying can include subjecting the precursor composition to mixing at a rotating speed of at least 1,000 rpm, such as at least 2,000 rpm, such as at least 3,000 rpm in the mixer.

The oil phase, for example, a base oil, can be introduced before or during the mixing. The mixing and/or emulsification can be performed as a batch process, or as a continuous process. The technique can further include adding an oil-based composition to the precursor composition during the emulsifying. In some aspects, which can be combined with other aspects, the precursor composition further includes the oil-based composition, for example, before mixing or emulsification is initiated.

Aspects of the present disclosure also generally relate to processes using drilling mud compositions described herein. In some aspects, which can be combined with other aspects, any suitable drilling mud composition described herein, such as a composition that includes asphalt sulfonate salt particles, graphene particles, and a base oil, can be introduced to a subterranean formation. The drilling mud composition can further include an aqueous carrier. Alternatively, the drilling mud composition can include an oil-based carrier that is different from the base oil. The process can further include producing natural resources such as oil, gas, and/or water from the subterranean formation. For example, the process can include producing hydrocarbons from the subterranean formation.

Drilling mud compositions described herein can be used during the production phase of natural resources, exploration phase of natural resources, or completion phases, among other phases. Wells can be drilled to extract natural resources such as oil, gas, or water. A wellbore is surrounded by a formation, for example, shale or clay, which can influence the stability of the wellbore. For example, the formation can exert pressure on the wellbore, or fluids from the formation can enter the wellbore. A formation can include permeable regions, and fluids introduced into the wellbore can enter the permeable regions, resulting in fluid loss. Such fluid loss can affect drilling efficiency, can entail replacement of drilling fluids, and affect the stability of the formation. Accordingly, drilling fluid compositions of the present disclosure can be used to promote stability of the formation, cooling and lubrication of drilling equipment, to remove cuttings and clear the borehole, among other functions.

Drilling mud compositions described herein, such as those including asphalt sulfonate salt particles, graphene particles, and a base oil, and optional additives, can be utilized with any suitable mud type, such as a water-based mud, a monovalent brine, a divalent brine, salt water, produced water, or combinations thereof.

Drilling mud compositions described herein can be mixed outside the formation, for example, by use of a mud hopper. Additionally, or alternatively, drilling mud compositions of the present disclosure can be added directly to the formation (or downhole) through the use of, for example, a mud pump.

Drilling mud compositions described herein, or components thereof, can be stored in a dry, ventilated area at a temperature above the freezing point of the composition. Any suitable container or packaging can be utilized to store drilling mud compositions described herein, such as a 275 gallon tote.

A drilling fluid described herein (for example, a fluid that includes the base oil, sodium asphalt sulfonate particles, graphene, optional one or more additional materials, and aqueous carrier) can be suitably formulated. An amount of the base oil, the asphalt sulfonate salt particles, and the graphene particles, and optionally one or more additional materials in an aqueous carrier can be any suitable amount, such as in a range from about 0.5 wt % to about 3.5 wt %, such as from about 1 wt % to about 3 wt %. An amount of the aqueous carrier can be in a range from about 96.5 wt % to about 99.5 wt %, such as from about 97 wt % to about 99 wt %.

A lubricant described herein (for example, a drilling mud composition) can include a base oil, sodium asphalt sulfonate particles, graphene, optional one or more additional materials, or combinations thereof). A concentration of lubricant in a circulating fluid useful for, e.g., drilling, can be in a range from about 0.5 wt % to about 3.5 wt %, such as from about 1 wt % to about 3 wt % based on a total wt % of the lubricant plus the circulating fluid. The total wt % of the lubricant plus the circulating fluid is equal to 100 wt %. In some aspects, which can be combined with other aspects, an amount of the circulating fluid can be in a range from about 1,000 bbl to about 1,500 bbl (about 42,000 gallons to about 63,000 gallons). The lubricant can be combined with the circulating fluid at the surface in a holding pit, and the resulting mixture of circulating fluid and lubricant can be pumped down hole, through the drill pipe and out the bit and circulated back to the surface. After circulation back to the surface, the mixture can be reused. For example, the mixture can be run through apparatus to remove dirt or particles from the mixture and then pumped down hole.

Aspects of the present disclosure also generally relate to methods using drilling mud compositions described herein. For example, a method of reducing torque and drag on drilling equipment when drilling is provided. The method can include introducing a composition described herein, for example, a composition comprising asphalt sulfonate salt particles, graphene particles, and a base oil to drilling equipment (e.g., in a subterranean formation). The drilling mud composition can further include an aqueous carrier. Alternatively, the drilling mud composition can include an oil-based carrier that is different from the base oil. The method can further include causing movement of the drilling equipment. By use of the drilling mud composition, the movement of the drilling equipment experiences less torque and drag than movement of the drilling equipment without the composition. If desired, this method of reducing torque and drag on drilling equipment when drilling can be performed during any suitable operation(s), for example, during drilling and/or producing of natural resources such as oil, gas, or water from the subterranean formation.

Compositions described herein can be used to form a tribofilm on drilling equipment. A method of forming a tribofilm on drilling equipment can include introducing a composition described herein, for example, a composition comprising asphalt sulfonate salt particles, graphene particles, and a base oil to drilling equipment (e.g., in a subterranean formation). The drilling mud composition can further include an aqueous carrier. Alternatively, the drilling mud composition can include an oil-based carrier that is different from the base oil. The method can further include causing movement of the drilling equipment, e.g., rotation and/or movement of drill strings, casings, etc. By use of the drilling mud composition, the movement of the drilling equipment can cause components of the composition to interact under shear to form a stable tribofilm on metallic surfaces as described herein, such as on a metal drill pipe surface. For example, the micronized graphene particles and the chemistry of one or more components present in the lubricant can facilitate formation of a protective tribofilm under shear, thereby minimizing metal-to-metal contact between, for example, a drill string, a bottom hole assembly, and a casing. The tribofilm can serve to significantly lower the coefficient of friction and serve to mitigate wear in harsh drilling environments, extending the service life of equipment such as bottom hole assemblies and drill strings. If desired, this method of forming a tribofilm on drilling equipment can be performed during any suitable operation(s), for example, during drilling and/or producing of natural resources such as oil, gas, or water from the subterranean formation.

Compositions described herein can be used for drilling various wellbores including, but not limited to, extended lateral wellbores. A method of drilling an extended lateral wellbore can include introducing a composition described herein, for example, a composition comprising asphalt sulfonate salt particles, graphene particles, and a base oil to drilling equipment (e.g., in a subterranean formation). The method can further include drilling an extended lateral wellbore before, during, and/or after introducing the composition to the drilling equipment.

Aspects of the present disclosure can be further understood by the following non-limiting examples. The following non-limiting examples are put forth so as to provide those of ordinary skill in the art with a complete disclosure and description of how to make and use aspects of the present disclosure and are not intended to limit the scope of aspects of the present disclosure.

### EXAMPLES

High torque and drag represent limitations in drilling, such as directional and extending drilling. While various factors affect torque and drag, controlling friction is important. The Examples include investigation of the COF of various compositions described herein.

COF measurements (Stribeck COF, traction COF, and POD COF) were determined by Micro Traction Machine (MTM) equipment (PCS Instruments, MTM2), controlling temperature, load, and rotation speed per ASTM Designation G-99-23 “Standard Test Method for Wear and Friction Testing with a Pin-on-Disk or Ball-on-Disk.” American Petroleum Institute (API) test set 13B-1 was utilized for compositions including a water-based carrier, and test set 13B-2 was utilized for compositions including an oil-based carrier.

The COFs are measured in the range of the rotating speeds, but also average values can be calculated. The rotating speeds are correlated to the rotating speed of the rotary assembly in real conditions. For example, 50 RPM of rotation in 5-inch drill pipe corresponds to about 400 mm/s speed in the tribometer. The tribometer allows for better examination of the effects of temperature, rotating speed, and load.

The friction data measured by the tribometer was utilized to build Stribeck curves. Stribeck curves display a full spectrum of the COF instead of a single value obtained by using standard methods (EP Lubricity Meter). In tribology—the science of lubrication, friction, and wear—speed-dependent film formation and changes in the frictional properties are portrayed through “Stribeck curves”. The Stribeck curve describes the different lubrication regimes while changing rotation speed. According to the Stribeck curve, which describes a relationship between the COF and vη/N, where v is relative velocity, η is fluid viscosity, and N is the contact pressure, the static COF and the COF at low speeds are relatively high, compared to values at higher speeds. The COF measurements described herein include use of Stribeck curves to obtain the full spectrum of COF and the influence of temperature, rotating speed, and load.

### Example 1

The lubricity properties of water-based drilling mud compositions including different concentrations of SAS, graphene, and PAO were evaluated. The base mud composition (“base”) included bentonite, polyanionic cellulose (Drispac® Superlo®), a biopolymer (Flowzan® Biopolymer), 6-micron calcium carbonate, and soda ash. The base mud had a density of 8.575 lbm/gal. The composition of the base mud is presented in Table 1. The term “lbm/bbl” refers to pounds per barrel.

TABLE 1

| Component | Concentration, lbm/bbl |
|---|---|
| Bentonite | 10.0 |
| Polyanionic cellulose | 1.0 |
| Flowzan ® biopolymer | 0.8 |
| Calcium carbonate | 5.0 |
| Soda ash | 1.0 |

Two samples were prepared: Sample A1 is base; and Sample B1 is base with 3% by volume mixed lubricant (6.91 lbm/bbl Synfluid® Mixed Dimer, 1.42 lbm/bbl graphene, 0.47 lb/bbl Drill-Sure™, 0.47 lbm/bbl surfactant, and 0.19 lbm/bbl suspension agent). The suspension agent used for the sample is a styrenic thermoplastic block copolymer. The surfactant used for the sample is Bio-Soft N25-12. The samples were hot rolled for 16 hours at 200° F. (93° C.). The rheological properties of the samples, such as plastic viscosity, yield point, and gel strength were determined using a rotational viscometer, and are presented in Table 2.

TABLE 2

| | Sample A1 | Sample B1 |
|---|---|---|
| 600 rpm, cp | 30.8 | 19.9 |
| 300 rpm, cp | 19.4 | 11.4 |
| 200 rpm, cp | 15.1 | 8.6 |
| 100 rpm, cp | 9.7 | 5.4 |
| 6 rpm, cp | 1.3 | 1.0 |
| Viscosity at 3 rpm, cP | 1.0 | 0.9 |
| Plastic viscosity, cP | 10.7 | 7.1 |
| Yield point, lb/100 ft² | 8.3 | 4.6 |
| Gel strength, lb/100 ft² | 1.6/1.8 | 0.7/1.5 |
| (10 second/10 minute) | | |

Sample B2 was prepared. Sample B2 is base with 3% by volume mixed lubricant (6.91 lbm/bbl PAO-2 and 1.42 lbm/bbl graphene). Sample C1 was also prepared. Sample C1 is base with 3% by volume graphene (1.42 lbm/bbl graphene).

The COF was evaluated using a tribometer at 100° F., 150° F., and 200° F. to build Stribeck curves. At 100° F. (38° C.), Sample B2 (base with graphene and PAO-2) exhibited a COF that was significantly lower than Sample C1 (base with graphene) and Sample A1 (base). For example, at a rotating speed of 112 mm/s and at a temperature of 100° F. (38° C.), the COFs determined were: 0.352 (Sample A1), 0.059 (Sample B2), and 0.094 (Sample C1). At 150° F., Sample B2 exhibited a COF that was generally lower than Sample C1 and Sample A1. For example, at a rotating speed of 16 mm/s and at a temperature of 150° F. (66° C.), the COFs determined were 0.372 (Sample A1), 0.057 (Sample B2), and 0.076 (Sample C1). The results for the COF at 200° F. (93° C.) are presented in Table 3 and illustrated in FIG. 1. In FIG. 1, “base” is Sample A1, “PAO-2+Graphene” is Sample B2, and “Graphene” is Sample C1.

TABLE 3

| Rotating | Sample | Sample | Sample |
|---|---|---|---|
| speed, mm/s | A1 | B2 | C1 |
| 1,200 | 0.281 | 0.135 | 0.097 |
| 947 | 0.27 | 0.134 | 0.097 |
| 748 | 0.308 | 0.098 | 0.104 |
| 590 | 0.297 | 0.1 | 0.098 |
| 466 | 0.298 | 0.091 | 0.101 |
| 368 | 0.329 | 0.069 | 0.101 |
| 290 | 0.326 | 0.065 | 0.093 |
| 229 | 0.304 | 0.075 | 0.089 |
| 181 | 0.324 | 0.071 | 0.097 |
| 142 | 0.327 | 0.059 | 0.087 |
| 112 | 0.352 | 0.059 | 0.094 |
| 89 | 0.316 | 0.059 | 0.07 |
| 70 | 0.337 | 0.056 | 0.093 |
| 55 | 0.346 | 0.068 | 0.092 |
| 43 | 0.326 | 0.052 | 0.084 |
| 34 | 0.351 | 0.054 | 0.083 |
| 27 | 0.359 | 0.06 | 0.069 |
| 21 | 0.286 | 0.045 | 0.071 |
| 16 | 0.303 | 0.051 | 0.078 |
| 13 | 0.199 | 0.04 | 0.075 |
| 10 | 0.225 | 0.049 | 0.081 |
| 8 | 0.213 | 0.074 | 0.076 |
| 6.5 | 0.32 | 0.042 | 0.119 |
| 5.2 | 0.087 | 0.043 | 0.038 |
| 3.8 | 0.205 | 0.052 | 0.077 |
| 3 | 0.39 | 0.047 | 0.07 |
| 2.6 | 0.21 | 0.094 | 0.096 |
| 1.9 | 0.37 | 0.069 | 0.09 |
| 1.4 | 0.214 | 0.052 | 0.097 |
| 1.3 | 0.181 | 0.055 | 0.063 |
| 0.9 | 0.19 | 0.057 | 0.067 |
| — | — | — | — |

As shown in Table 3, at 200° F. (93° C.), Sample B2 (base with graphene and PAO-2) exhibited a COF that was generally lower than Sample C1 (base with graphene) and Sample A1 (base). For example, at a rotating speed of 43 mm/s and at a temperature of 200° F. (93° C.), the COFs determined were: 0.326 (Sample A1), 0.052 (Sample B32), and 0.084 (Sample C1). At a rotating speed of 290 mm/s and at a temperature of 200° F. (93° C.), the COFs were determined to be 0.326 (Sample A1), 0.065 (Sample B32), and 0.093 (Sample C1).

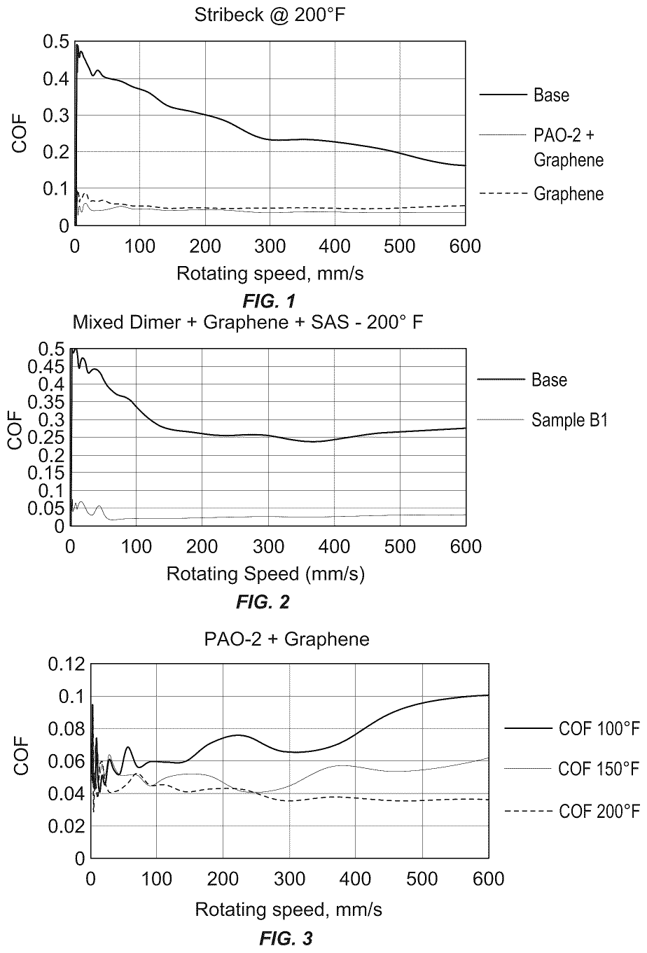

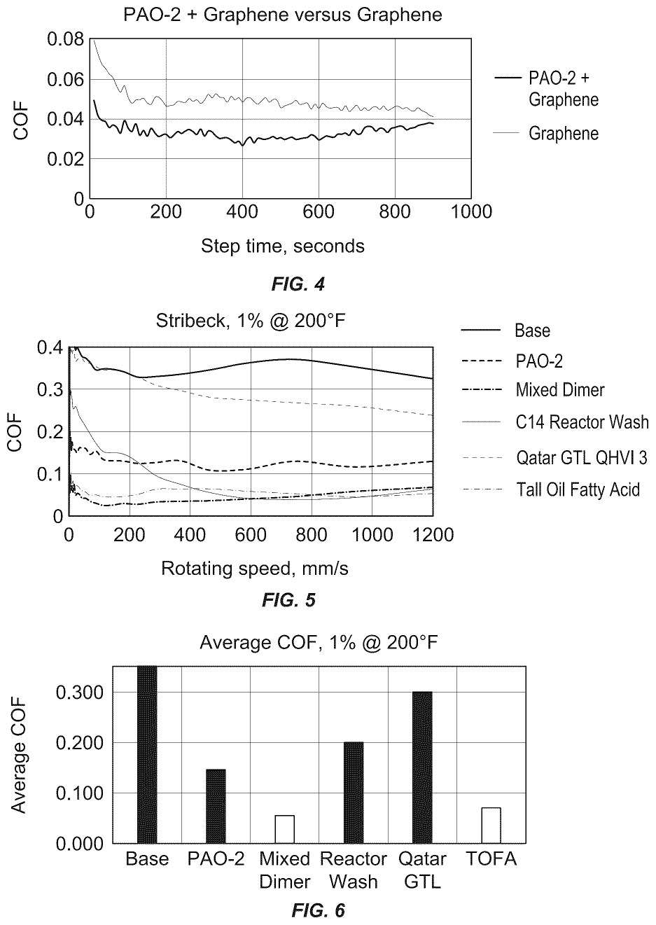

The Stribeck curves at 200° F. (93° C.) for Samples A1, B2, and C1 are shown in FIG. 1. FIG. 1 indicates that Sample B2 and Sample C1 significantly outperform Sample A1. FIG. 2, which shows the Stribeck curves at 200° F. (93° C.) for Sample A1 (“Base”) and Sample B1 (“Base+Mixed Dimer+Graphene+SAS”), indicates that Sample B1 significantly outperforms Sample A1. FIG. 4, which shows Sample B2 (“PAO-2+Graphene”) and Sample C1 (“Graphene”), indicates that Sample B2 outperformed Sample C1. Together, FIGS. 1, 2, and 4 show the synergy between the PAO-2 or Synfluid® Mixed Dimer and graphene in the range of rotating speeds tested, with the synergistic effect being larger at low rotating speeds.

Overall, Example 1 demonstrates that graphene can be used in water-based mud compositions. Conventionally, forming stable dispersions of solid graphene has proven difficult in the presence of water. In contrast, compositions described herein are stable and show super-lubricity. Moreover, Example 1 shows a synergy between graphene particles and the PAO-2 base oil or Synfluid® Mixed Dimer base oil. Example 1 also shows synergy between the graphene particles, SAS particles, and the base oil (PAO-2 base oil or Synfluid® Mixed Dimer base oil). The synergy can enable, for example, the solid graphene particles to serve as a lubricant in the presence of water. The synergy can also provide the low COF in the presence of water.

### Example 2

The properties of water-based drilling mud compositions including different concentrations of graphene and SAS were evaluated. The base mud composition (“base”) included bentonite (7.0 lbm/bbl), polyanionic cellulose (Drispac® Superlo®, 2 lbm/bbl), a biopolymer (Flowzan® Biopolymer, 0.75 lbm/bbl), Rev Dust™ Inert Particulate (10 lbm/bbl Milwhite, Inc., Brownsville, Tex.), caustic soda (0.5 lbm/bbl), sodium sulfite (2 lbm/bbl), and barite (20 lbm/bbl). The base composition had a density of 9.0 lbm/gal.

Samples A2, B3, C2, and D1 were prepared by mixing the base with 3 vol % of the following lubricant: 15% by weight graphene, 15% by weight Drill-Sure™ (SAS), 5% by weight surfactant, 2% by weight suspension agent, and 63% by weight base oil (mixed dimer, C14 reactor wash, Qatar GTL QHVI 3, or TOFA).

The surfactant used for the samples is Bio-Soft N25-12. The suspension agent used for the samples is a styrenic thermoplastic block copolymer.

The base oil used for Sample A2 is the mixed dimer (Synfluid® Mixed Dimer base oil). The base oil used for Sample B3 is the C14 reactor wash. The base oil used for Sample C2 is the Qatar GTL QHVI 3. The base oil used for Sample D1 is the TOFA.

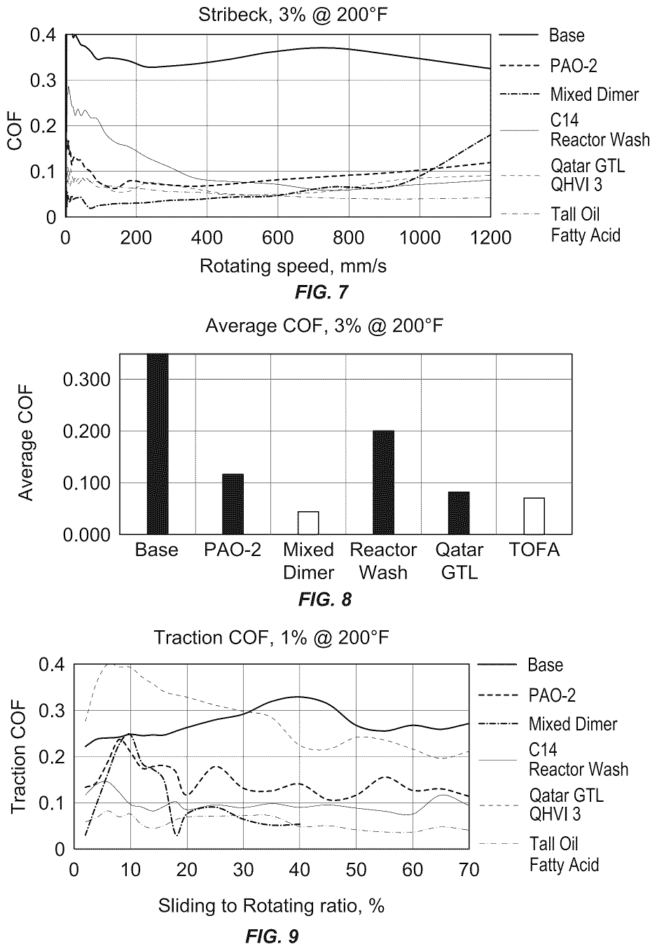

The COF was evaluated using a tribometer at 100° F., 150° F., and 200° F. to build Stribeck curves. The results for COF at 200° F. (93° C.) are presented in Table 4 and illustrated in FIG. 7. In FIG. 7, “Base” refers to Sample A1, “PAO-2” refers to Sample B2, “Mixed Dimer” refers to Sample A2, “C14 Reactor Wash” refers to Sample B3, “Qatar GTL QHVI 3” refers to Sample C2, and “Tall Oil Fatty Acid” refers to Sample D1. The results indicate that the type of lubricant (base oil) plays a role in COF.

TABLE 4

| Rotating | | | | |
|---|---|---|---|---|
| speed, | Sample | Sample | Sample | Sample |
| mm/s | A2 | B3 | C2 | D1 |
| 1200 | 0.1797 | 0.0808 | 0.0909 | 0.0421 |
| 947 | 0.072 | 0.0688 | 0.0819 | 0.0397 |
| 748 | 0.0657 | 0.0582 | 0.0567 | 0.0416 |
| 590 | 0.0461 | 0.0721 | 0.0494 | 0.0468 |
| 466 | 0.0435 | 0.0777 | 0.05 | 0.0489 |
| 368 | 0.0383 | 0.0848 | 0.0612 | 0.0544 |
| 290 | 0.0362 | 0.1103 | 0.0705 | 0.0559 |
| 229 | 0.0314 | 0.1309 | 0.0748 | 0.061 |
| 181 | 0.0299 | 0.1624 | 0.0565 | 0.0641 |
| 142 | 0.0267 | 0.1624 | 0.0544 | 0.0669 |
| 112 | 0.0267 | 0.1826 | 0.065 | 0.0693 |
| 89 | 0.0244 | 0.2148 | 0.066 | 0.0776 |
| 70 | 0.019 | 0.2181 | 0.077 | 0.0782 |
| 55 | 0.0298 | 0.2338 | 0.0792 | 0.0867 |
| 43 | 0.0432 | 0.222 | 0.0874 | 0.0799 |
| 34 | 0.042 | 0.2364 | 0.0826 | 0.0732 |
| 27 | 0.0411 | 0.2223 | 0.0754 | 0.0854 |
| 21 | 0.0388 | 0.24 | 0.083 | 0.0742 |
| 16 | 0.0473 | 0.2443 | 0.0908 | 0.0814 |
| 13 | 0.0354 | 0.2631 | 0.1071 | 0.0685 |
| 10 | 0.0337 | 0.2774 | 0.0829 | 0.0738 |
| 8 | 0.0452 | 0.2857 | 0.0909 | 0.071 |
| 6.5 | 0.0406 | 0.27 | 0.1089 | 0.0814 |
| 5.2 | 0.053 | 0.2682 | 0.0919 | 0.077 |
| 3.8 | 0.0225 | 0.224 | 0.0986 | 0.0887 |
| 3.5 | 0.0457 | 0.2531 | 0.0755 | 0.0931 |
| 2.6 | 0.0517 | 0.1385 | 0.1584 | 0.097 |
| 1.9 | 0.0662 | 0.2169 | 0.1051 | 0.0945 |
| 1.4 | 0.0287 | 0.1607 | 0.0876 | 0.1068 |
| 0.9 | 0.00664 | 0.1148 | 0.105 | 0.0594 |

### Example 3

Sample B2, described above, was used to observe the COF at various temperatures. The COF was evaluated using a tribometer at 100° F. (38° C.), 150° F. (66° C.), and 200° F. (93° C.) to build the Stribeck curves. The results for the variation of COF with temperature for Sample B2 (graphene and PAO-2) are shown in Table 5, where Sample 3-1 is COF at 100° F. (38° C.), Sample 3-2 is COF at 150° F. (66° C.), and Sample 3-3 is COF at 200° F. (93° C.). The results are also illustrated in FIG. 3, where “COF 100° F.” refers to Sample 3-1, “COF 150° F.” refers to Sample 3-2, and “COF 200° F.” refers to Sample 3-3.

TABLE 5

| Rotating | Sample | Sample | Sample |
|---|---|---|---|
| speed, mm/s | 3-1 | 3-2 | 3-3 |
| 1,200 | 0.135 | 0.132 | 0.092 |
| 947 | 0.134 | 0.103 | 0.042 |
| 748 | 0.098 | 0.080 | 0.030 |
| 590 | 0.100 | 0.06 | 0.036 |
| 466 | 0.091 | 0.053 | 0.035 |
| 368 | 0.069 | 0.056 | 0.037 |
| 290 | 0.065 | 0.043 | 0.035 |
| 229 | 0.075 | 0.041 | 0.042 |
| 181 | 0.071 | 0.070 | 0.042 |
| 142 | 0.059 | 0.051 | 0.040 |
| 112 | 0.059 | 0.049 | 0.045 |
| 89 | 0.059 | 0.044 | 0.045 |
| 70 | 0.056 | 0.051 | 0.052 |
| 55 | 0.068 | 0.051 | 0.046 |
| 43 | 0.052 | 0.051 | 0.042 |
| 34 | 0.054 | 0.056 | 0.040 |
| 27 | 0.060 | 0.063 | 0.040 |
| 21 | 0.045 | 0.051 | 0.046 |
| 16 | 0.056 | 0.076 | 0.074 |
| 13 | 0.051 | 0.057 | 0.059 |
| 10 | 0.049 | 0.064 | 0.039 |
| 8 | 0.074 | 0.065 | 0.042 |
| 6.5 | 0.042 | 0.069 | 0.043 |
| 5.2 | 0.042 | 0.063 | 0.037 |
| 3.8 | 0.052 | 0.048 | 0.029 |
| 3.5 | 0.047 | 0.048 | 0.093 |
| 2.6 | 0.094 | 0.071 | 0.060 |
| 1.9 | 0.069 | 0.061 | 0.055 |
| 1.4 | 0.052 | 0.072 | 0.047 |
| 1.3 | 0.055 | 0.056 | 0.058 |
| 0.9 | 0.057 | 0.067 | 0.070 |
| — | — | — | — |

As shown in Table 5, the COF generally decreases as the temperature increases from 100° F. (38° C.) to 200° F. (93° C.). Table 5 and FIG. 3 also show the very low COF achieved using aspects of the present disclosure at all temperatures tested. The data indicates that the synergy between the PAO-2 and graphene can be activated with temperature.

### Example 4

The results for the variation of COF with time and temperature was determined by heating Sample B2 (base with graphene and PAO-2) and C1 (base with graphene) to 200° F. (93° C.) and allowing it to cool. Data are presented in Table 6 and in FIG. 4, where “PAO-2+Graphene” refers to Sample B2 and “Graphene” refers to Sample C1. Step time is measured in seconds (s), and COF was measured at 10 second intervals. The data in Table 6 and FIG. 4 indicates that Sample B2 (base with PAO-2 and graphene) significantly outperformed Sample C1 (base with graphene).

TABLE 6

| Step | Sample | Sample | Step | Sample | Sample |
|---|---|---|---|---|---|
| time, s | B2 | C1 | time, s | B2 | C1 |
| 10 | 0.0491 | 0.0793 | 490 | 0.0302 | 0.0494 |
| 20 | 0.0418 | 0.0727 | 500 | 0.0307 | 0.0457 |
| 30 | 0.0393 | 0.0677 | 510 | 0.0298 | 0.0465 |
| 40 | 0.0386 | 0.0653 | 520 | 0.0304 | 0.0472 |
| 50 | 0.0357 | 0.0625 | 530 | 0.0309 | 0.0479 |
| 60 | 0.0369 | 0.0606 | 540 | 0.0298 | 0.0493 |
| 70 | 0.0357 | 0.0562 | 550 | 0.0301 | 0.0473 |
| 80 | 0.0329 | 0.0534 | 560 | 0.0305 | 0.0476 |
| 90 | 0.0391 | 0.0566 | 570 | 0.0308 | 0.0479 |
| 100 | 0.0353 | 0.0506 | 580 | 0.0321 | 0.045 |
| 110 | 0.0338 | 0.0479 | 590 | 0.0313 | 0.0474 |
| 120 | 0.0375 | 0.0495 | 600 | 0.0296 | 0.0453 |
| 130 | 0.0319 | 0.0495 | 610 | 0.0305 | 0.0479 |
| 140 | 0.0342 | 0.0503 | 620 | 0.0315 | 0.0461 |
| 150 | 0.0314 | 0.048 | 630 | 0.0311 | 0.0454 |
| 160 | 0.0353 | 0.0473 | 640 | 0.0309 | 0.0457 |
| 170 | 0.033 | 0.0507 | 650 | 0.0324 | 0.0458 |
| 180 | 0.0312 | 0.0509 | 660 | 0.0324 | 0.0442 |
| 190 | 0.0321 | 0.0489 | 670 | 0.0329 | 0.0466 |
| 200 | 0.0323 | 0.0464 | 680 | 0.0319 | 0.0437 |
| 210 | 0.0307 | 0.0467 | 690 | 0.0345 | 0.0454 |
| 220 | 0.032 | 0.0471 | 700 | 0.0326 | 0.0468 |
| 230 | 0.0337 | 0.0488 | 710 | 0.0327 | 0.0442 |
| 240 | 0.0328 | 0.0485 | 720 | 0.0355 | 0.0456 |
| 250 | 0.034 | 0.0483 | 730 | 0.0363 | 0.0442 |
| 260 | 0.0347 | 0.0502 | 740 | 0.0358 | 0.0457 |
| 270 | 0.0336 | 0.0488 | 750 | 0.0339 | 0.0461 |
| 280 | 0.0323 | 0.0496 | 760 | 0.0353 | 0.0448 |
| 290 | 0.0349 | 0.0478 | 770 | 0.035 | 0.0464 |
| 300 | 0.0315 | 0.0494 | 780 | 0.0333 | 0.0444 |
| 310 | 0.034 | 0.0523 | 790 | 0.0352 | 0.0451 |
| 320 | 0.0335 | 0.0506 | 800 | 0.0357 | 0.0462 |
| 330 | 0.0315 | 0.0526 | 810 | 0.0363 | 0.0462 |
| 340 | 0.0303 | 0.0509 | 820 | 0.0362 | 0.0451 |
| 350 | 0.0306 | 0.0506 | 830 | 0.0346 | 0.0457 |
| 360 | 0.0306 | 0.0484 | 840 | 0.0353 | 0.0444 |
| 370 | 0.0295 | 0.0513 | 850 | 0.0356 | 0.044 |
| 380 | 0.0281 | 0.0496 | 860 | 0.0366 | 0.0456 |
| 390 | 0.0289 | 0.0506 | 870 | 0.0371 | 0.0442 |
| 400 | 0.0268 | 0.0485 | 880 | 0.0375 | 0.0434 |
| 410 | 0.0295 | 0.0504 | 890 | 0.038 | 0.0419 |
| 420 | 0.0309 | 0.0505 | 900 | 0.0376 | 0.0412 |
| 430 | 0.0282 | 0.0487 | 850 | 0.0356 | 0.044 |
| 440 | 0.0304 | 0.0474 | 860 | 0.0366 | 0.0456 |
| 450 | 0.0301 | 0.0491 | 870 | 0.0371 | 0.0442 |
| 460 | 0.0299 | 0.0506 | 880 | 0.0375 | 0.0434 |
| 470 | 0.0304 | 0.0484 | 890 | 0.038 | 0.0419 |
| 480 | 0.0312 | 0.0497 | 900 | 0.0376 | 0.0412 |

### Example 5

Sample A1 and Sample B1 were used for this example. Sample A1 is base without lubricant. Sample B1 is described above. The COF was measured at various rotating speeds and at 100° F. (38° C.), 150° F. (66° C.), and 200° F. (93° C.). Sample A1 was tested at 100° F. (38° C.). Sample B1 was tested at 100° F. (38° C.), 150° F. (66° C.), and 200° F. (93° C.).

TABLE 7

| Rotating | Sample | Sample | Sample | Sample |
|---|---|---|---|---|
| speed, | A1 | B1 | B1 | B1 |
| mm/s | (38° C.) | (38° C.) | (66° C.) | (93° C.) |
| 1200 | 0.1591 | 0.0729 | 0.0969 | 0.0818 |
| 947 | 0.1403 | 0.0758 | 0.0995 | 0.0459 |
| 748 | 0.13 | 0.0663 | 0.0772 | 0.0428 |
| 590 | 0.1449 | 0.0666 | 0.071 | 0.0305 |
| 466 | 0.1551 | 0.0642 | 0.054 | 0.0289 |
| 367 | 0.1609 | 0.0544 | 0.0503 | 0.0241 |
| 290 | 0.159 | 0.0501 | 0.0417 | 0.0259 |
| 229 | 0.171 | 0.0523 | 0.0386 | 0.0238 |
| 181 | 0.1702 | 0.0414 | 0.0415 | 0.0218 |
| 143 | 0.1696 | 0.0337 | 0.0366 | 0.0213 |
| 113 | 0.1843 | 0.0358 | 0.0366 | 0.0207 |
| 89 | 0.1989 | 0.0488 | 0.0317 | 0.0204 |
| 70 | 0.227 | 0.0437 | 0.0353 | 0.0175 |
| 55 | 0.271 | 0.0387 | 0.0534 | 0.0212 |
| 44 | 0.3002 | 0.0453 | 0.0479 | 0.0563 |
| 35 | 0.3155 | 0.0381 | 0.0453 | 0.0318 |
| 27 | 0.3191 | 0.0461 | 0.0439 | 0.0357 |
| 21 | 0.3263 | 0.0318 | 0.0443 | 0.0556 |
| 17 | 0.3445 | 0.0462 | 0.0586 | 0.068 |
| 13 | 0.3838 | 0.0699 | 0.0631 | 0.0639 |
| 11 | 0.3718 | 0.0412 | 0.0443 | 0.0478 |
| 8 | 0.3992 | 0.0402 | 0.0403 | 0.0645 |
| 6 | 0.4047 | 0.0315 | 0.0515 | 0.0514 |
| 5 | 0.3659 | 0.0486 | 0.0595 | 0.0543 |
| 4 | 0.4278 | 0.0647 | 0.0477 | 0.0411 |
| 3 | 0.419 | 0.0394 | 0.0503 | 0.0653 |
| 2 | 0.4103 | 0.083 | 0.0482 | 0.0735 |
| 1.8 | 0.3857 | 0.0466 | 0.0701 | 0.0425 |
| 1.7 | 0.3689 | 0.0267 | 0.0261 | 0.1009 |
| 1.3 | 0.2221 | 0.0461 | 0.0636 | 0.0451 |
| 1 | 0.0658 | 0.0325 | 0.0576 | 0.059 |

Overall, the data in Table 7 shows that drilling mud compositions of the present disclosure, for example, compositions having graphene and SAS, significantly outperform a drilling mud without graphene and SAS.

### Example 6

In this example, a water-based drilling mud composition that includes PAO-2 was compared with a water-based drilling mud composition that includes PAO-2 and graphene. Results are shown in FIG. 4. The results indicate that the COF decreases to less than 0.4 to about 0.3. The results also show the synergy between the PAO-2 and the graphene.

### Example 7

Water-based drilling mud compositions were also made using 1 wt % of a blend comprising 65 wt % of the comparative base mud shown in Table 1 or the various base oils with 15 wt % graphene, 15 wt % SAS, 3 wt % surfactant (a C12-C15 linear alcohol ethoxylate), and 2 wt % polymer (a styrene-ethylene/propylene-styrene (SEPS) polymer). Stribeck tests were performed at 200° F. Results are shown in FIG. 5. The various base oils included PAO-2, mixed dimer, C14 reactor wash, Qatar GTL QHVI 3, and tall oil fatty acid.

FIG. 5 is a plot illustrating the COF at 200° F. and different rotational speeds for water-based drilling mud compositions. FIG. 6 is a bar chart illustrating the average COF at 200° F. for the water-based drilling mud compositions using the different base fluids. FIG. 5 shows that drilling mud compositions of the present disclosure that comprise a base oil such as PAO-2, mixed C10-C12 dimer, C14 hydrocarbon, GTL, or TOFA significantly outperform those drilling mud compositions without such base oils. The results can also show the synergy between the base oil, graphene, and SAS. The data also indicate that mixed C10-C12 dimer and TOFA reach very low COFs under the conditions tested. The results in FIG. 6 indicate that the average COF over the various rotating speeds is significantly lower when using a base oil such as PAO-2, mixed C10-C12 dimer, C14 hydrocarbon, GTL, or TOFA, with mixed C10-C12 dimer and TOFA outperforming the others under the conditions tested.

### Example 8

In this example, drilling mud compositions with different base oils were examined. The base oils investigated included PAO-2, mixed C10-C12 dimer (referred to as mixed dimer in the figures), C14 reactor wash, Qatar GTL QHVI 3 oil, and TOFA. These were compared to a base mud, e.g., the base mud of Table 1.

Water-based drilling mud compositions were made and included 3 wt % of a blend comprising 65 wt % of the comparative base mud shown in Table 1 or the base oils as described in the preceding paragraph with 15 wt % graphene, 15 wt % SAS, 3 wt % surfactant (a C12-C15 linear alcohol ethoxylate), and 2 wt % polymer (a styrene-ethylene/propylene-styrene (SEPS) polymer). Stribeck tests were performed at 200° F.

FIG. 7 is a plot illustrating the COF at 200° F. and different rotational speeds for water-based drilling mud compositions. In FIG. 7, “Base” is Sample A1, “PAO-2” is Sample B2, “Mixed Dimer” is Sample A2, “C14 Reactor Wash” is Sample B3, “Qatar GTL QHVI 3” is Sample C2, and “Tall Oil Fatty Acid” is Sample D1. FIG. 8 is a bar chart illustrating the average COF at 200° F. for the water-based drilling mud compositions of these Samples. FIG. 7 shows that drilling mud compositions of the present disclosure that comprise a base oil such as PAO-2, mixed C10-C12 dimer, C14 hydrocarbon, GTL, or TOFA significantly outperform those drilling mud compositions without such base oils. The results can also show the synergy between the base oil, graphene, and SAS. The data also indicate that mixed C10-C12 dimer and TOFA reach very low COFs under the conditions tested. The results in FIG. 8 indicate that the average COF over the various rotating speeds is significantly lower when using a base oil such as PAO-2, mixed C10-C12 dimer, C14 hydrocarbon, GTL, or TOFA, with mixed C10-C12 dimer and TOFA outperforming the others under the conditions tested.

In addition, the water-based drilling mud compositions that included 3 wt % of the blend (described in this example) show improved or similar results relative to the water-based drilling mud compositions that include 1 wt % of the blend (described in Example 7) for many of the base oils investigated.

### Example 9

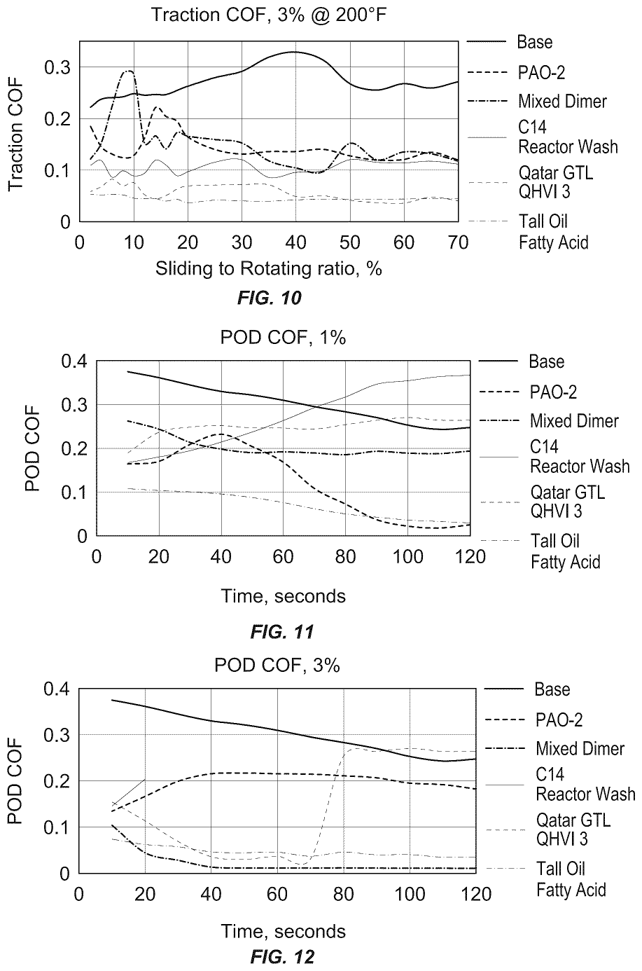

Traction COF and pin on disk (POD) COF for water-based drilling mud compositions of the present disclosure were also tested. The Stribeck tests were performed at 200° F. Results for the water-based drilling mud compositions that include 1 wt % of the blend (described in Example 7) are shown in FIG. 9 (traction COF) and FIG. 11 (POD COF). The tribometer was stopped at about 40%, as shown in FIG. 9, with respect to the mixed dimer sample. Results for the water-based drilling mud compositions that include 3 wt % of the blend (described in Example 8) are shown in FIG. 10 (traction COF) and FIG. 12 (POD COF). The tribometer was stopped at about 20%, as shown in FIG. 12, with respect to the reactor wash sample. In FIGS. 9-12, “Base” is Sample A1, “PAO-2” is Sample B2, “Mixed Dimer” is Sample A2, “C14 Reactor Wash” is Sample B3, “Qatar GTL QHVI 3” is Sample C2, and “Tall Oil Fatty Acid” is Sample D1.

The results show that water-based drilling mud compositions described herein achieve excellent traction COF and POD COF values.

With respect to the water-based drilling mud compositions that included 1 wt % of the blend, the lowest traction COF values (FIG. 9) were achieved using mixed C10-C12 dimer or TOFA under the conditions tested, while the lowest POD COF values (FIG. 11) were achieved using the GTL (Qatar GTL QHVI 3 oil) or TOFA under the conditions tested.

With respect to the water-based drilling mud compositions that included 3 wt % of the blend, the lowest traction COF values (FIG. 10) were achieved using the GTL (Qatar GTL QHVI 3 oil) or TOFA under the conditions tested, while the lowest POD COF values (FIG. 12) were achieved using the mixed C10-C12 dimer or TOFA under the conditions tested. Overall, the data indicates that various drilling mud compositions including, for example, mixed C10-C12 dimer or TOFA show a decrease in traction COF and POD COF and then a relatively steady COF, indicating a good tribofilm has formed.

### Example 10

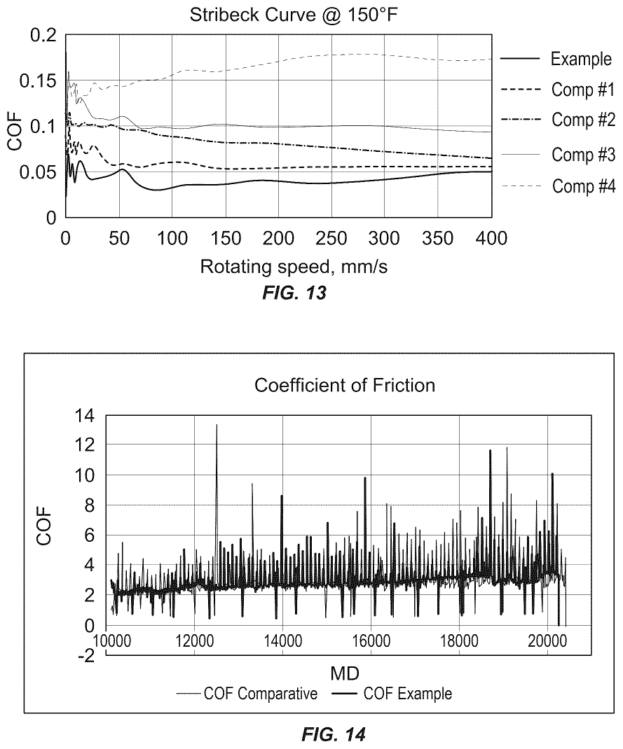

Stribeck curves at 150° F. of an example drilling mud composition described herein (3% base fluid (mixed dimer) with 15% graphene, 5% SAS, 2% suspension agent, and 5% emulsifier, similar to Sample B1) and conventional commercially available drilling mud compositions (Comp #1 (EP mud lube), #2 (Mil lube), #3 (ProSlide), and #4, (Ultralube)) were compared. FIG. 13 shows that, relative to conventional technologies, drilling mud compositions of the present disclosure have a significantly reduced COF.

### Example 11: Field Trial

The Bakken Formation, located within the Williston Basin of North Dakota includes three primary zones, Upper Bakken Shale, Middle Bakken Shale, and Lower Bakken Shale. Among these zones, the Middle Bakken Shale is the most frequently targeted for hydrocarbon production due to its porosity and permeability. However, this zone also presents significant drilling challenges due to its complex lithology and rock properties. Despite these challenges, the Middle Bakken holds substantial untapped reserves with the potential for high oil recovery.

During the field trial, sufficient volumes of an example drilling mud composition (3% mixed dimer with 15% graphene, 5% SAS, 5% emulsifier, 2% suspension agent, i.e., Sample B1; this was used in all field trials) were deployed to support a 5 well pad, pumping about 3% v/v sweeps according to an established pumping schedule. Throughout the field trial, drilling parameters were continuously monitored and recorded, including, Weight on Bit (WOB), torque, Rate of Penetration (ROP), pump pressure, mud properties, and shock and vibration. A plot of COF versus measured depth for the example drilling mud composition described herein (i.e., Sample B1) (COF Example) was compared to a conventional lubricant (Drill-Lube He lubricant from Drill-Chem) (COF Comparative) is shown in FIG. 14. The data indicates the superior performance of the example drilling mud composition described herein over a wide range of drilling depths. In FIG. 14, “MD” refers to measured depth.

The field trial results confirmed and validated the initial tests conducted in the laboratory, exhibiting reduction in torque and decreased wear on metal drill pipe. Comparing the field trial results to offset wells using a conventional lubricant (Drill-Lube He lubricant), the use of drilling mud compositions described herein reduced the torque by an additional 2% consistently, showed a 64% decrease in pipe wear, and successful drilling through the Middle Bakken, the most technically demanding section, with controlled torque. This enabled the operator to drill a lateral section in significantly less time than conventional technologies, confirming the effectiveness of drilling mud compositions described herein in enhancing drilling performance in challenging formations and environments. At the same time, drilling mud compositions of the present disclosure can reduce hard-banding (corresponding to a reduction in drill pipe wear) by over 60% compared to offset wells.

### Example 13: Field Trial

In a field trial using a land-based drilling rig in the Bakken Basin, North Dakota, torque on the drilling equipment was recorded using an example water-based mud composition (Sample B1 in Bakken brine carrier fluid at a volume ratio of 1-3% v/v (lubricant in carrier fluid)) versus a comparative conventional water-based mud composition (Drill-Lube He lubricant from Drill-Chem at a volume ratio of 1-3% v/v (lubricant in carrier fluid)). In separate investigations, sufficient volumes of the example or conventional water-based mud composition example drilling mud composition were deployed to support a 5-well pad according to an established pumping schedule. As shown in Table 8, use of the example water-based mud composition resulted in lower minimum torque, lower maximum torque, and lower average torque than the conventional water-based mud composition (comparative example).

TABLE 8

| | Minimum torque, | Maximum torque, | Average torque, |
|---|---|---|---|
| Sample | ft · lbf | ft · lbf | ft · lbf |
| Example | 0.04 | 21.30 | 18.10 |
| Comparative | 0.19 | 22.59 | 18.41 |
| Example | | | |

These results were surprising and unexpected considering the field trial involved drilling a more difficult path (in a harder formation) with the inventive example composition relative while a softer formation was drilled using the comparative conventional composition. That is, even when drilling a well in the more difficult formation, the overall torque was lower than the well drilled with the comparative conventional composition under better conditions (softer formation). Less pipe wear was also observed using the inventive example water-based mud composition relative to the comparative example. The field trial indicates that aspects of the present disclosure can provide, for example, measurable improvements in drilling efficiency and equipment longevity. The field trial also indicates that aspects of the present disclosure are useful in real-world drilling environments.

Other observations were noted. The inventive lubricant, which includes graphene particles, sodium asphalt sulfonate particles, and a base oil, in an aqueous carrier fluid was found to provide a mechanical barrier to reduce friction via the graphene particles, and to create a sustainable tribofilm. It was also found to prevent greasing and cheesing even in harsh mechanical and environmental conditions typical of unconventional shale. Relative to conventional lubricants, aspects described herein demonstrated significant improvements in equipment reliability, operational efficiency, and environmental compliance as shown in the field trial.

### Example 14

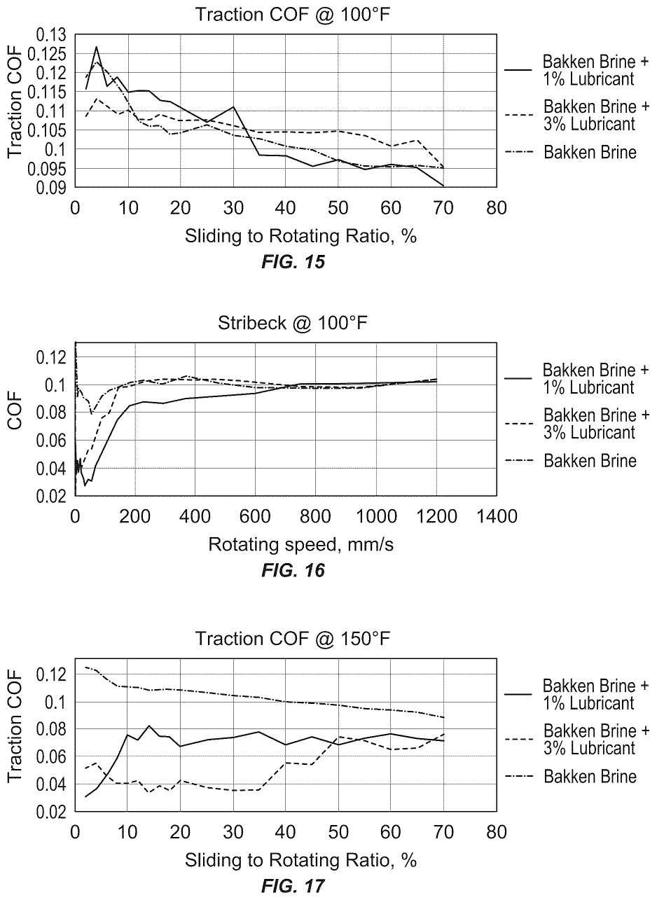

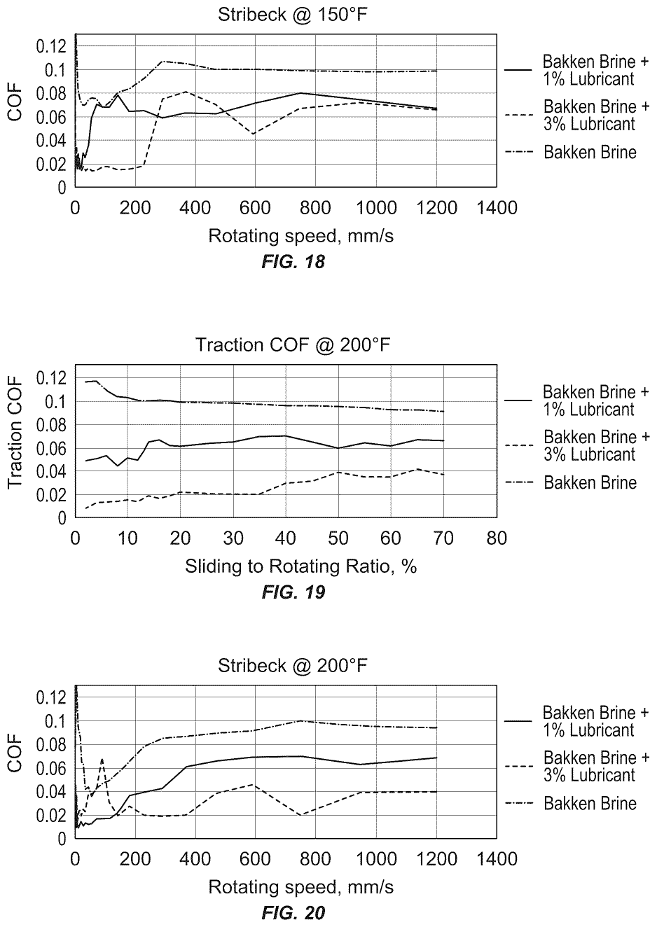

FIGS. 15, 17, and 19 show traction COF data at 100° F. (38° C.), 150° F. (66° C.), and 200° F. (93° C.), respectively, for water-based drilling mud compositions of the present disclosure that include Bakken brine as aqueous carrier with either 1% or 3% concentration of a lubricant comprising asphalt sulfonate salt particles, graphene particles, and a base oil (Sample B1). Bakken brine was used as a control. FIGS. 16, 18, and 20 show Stribeck curves at 100° F. (38° C.), 150° F. (66° C.), and 200° F. (93° C.), respectively, for the same water-based drilling mud compositions and control. The results in FIGS. 15-20 indicate that aspects of the present disclosure can be used with Bakken brine.

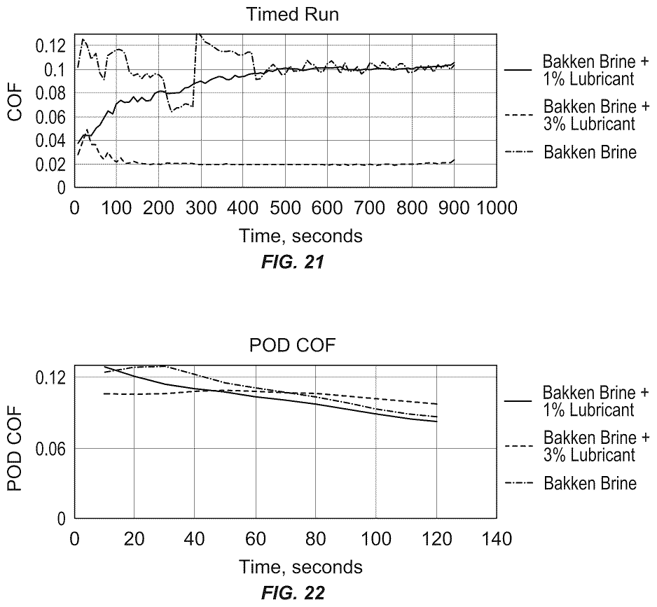

FIG. 21 shows a timed run for water-based drilling mud compositions of the present disclosure that include Bakken brine as aqueous carrier and either 1% or 3% concentration of a lubricant (Sample B1). Bakken brine was used as a control.

FIG. 22 is a plot showing Pin-On-Disk (POD) COF for water-based drilling mud compositions of the present disclosure that include Bakken brine as aqueous carrier and either 1% or 3% concentration of a lubricant (Sample B1). Bakken brine was used as a control.

### Example 15: Study of the Tribofilm

While not wishing to be bound by any theory, it is believed that the tribofilm can be responsible for the friction reduction between surfaces. Tribofilms formed by compositions of the present disclosure were studied by Raman spectroscopy. It was found that the tribofilm can include one layer adsorbed to the metallic surface due to chemical bonding, a second layer starting to be affected by the flow, and a third layer aligned parallel to the flow. The first layer of the solid-liquid lubricant was formed by the chemical adsorption of the sodium sulfonate asphalt (SAS), the second layer by SAS and graphene synergy, and the third layer constituted the low-viscosity base oil. The neutral characteristics of the base oil can facilitate the sliding between layers, contributing to the improvement of the COF in the hydrodynamic lubrication regime.

### Example 16: Laboratory Investigations

Lubricity performance was evaluated using two complementary laboratory instruments: Lubricity Evaluation Monitor and Mini Traction Machine. These tools were utilized to provide a comprehensive assessment of a lubricant's behavior under controlled metal-to-metal contact and wellbore-representative surface interactions.

The lubricity evaluation monitor (LEM) evaluates lubricity using a rotating steel bob immersed in a circulating cup of test fluid and pressed laterally against a representative wellbore material, such as casing steel or core samples. A pneumatic ram applies controlled side-load force, forcing the bob into contact with the test surface while frictional resistance is continuously measured. The LEM captures the interaction between the drilling fluid, the lubricant additive, and realistic wellbore materials. This configuration is effective for assessing tribofilm strength, durability, and surface affinity under sustained contact. The LEM can operate at temperatures up to 180° F. (82.2° C.) and apply loads up to 50 lb/in (5.6 N/m), providing valuable insight into lubricant performance under sidewall contact and sliding conditions encountered during drilling and tripping operations.

The mini traction machine (MTM) measures lubricity under a wide range of rolling and sliding conditions using a ball-on-disk configuration, where a steel ball is loaded against the face of a rotating disk. Both the ball and disk are independently driven, allowing precise control of slide-to-roll ratio, contact load, and sliding speed. As the drilling fluid lubricant passes through the contact zone, the MTM continuously measures the COF. The MTM provides both Traction results and a Stribeck curve. Traction testing and sliding tests under boundary conditions, where surface interactions occur, focuses on the effect of the lubricant in the boundary regime. Stribeck curve analysis, where friction is measured as a function of sliding speed at constant load, describes the different lubrication regimes while changing rotational speed. The Stribeck curve explains the relationship between the COF and vη/N, where v is relative velocity, η is fluid viscosity and N is the contact pressure. The static COF and the COF at low speeds are relatively high, compared to values at higher speeds. These tests characterize lubricant performance across boundary, mixed, and hydrodynamic lubrication regimes. The measured COF reflects the mechanical properties of the lubricant and the lubricant's ability to form a protective tribofilm on the contacting surfaces. Tribofilm formation is useful for sustained friction reduction under high load and elevated temperature conditions.

The MTM offers automated, highly repeatable test procedures with precise control of load, speed, temperature, and surface materials. These capabilities significantly reduce operator-dependent variability and enable meaningful comparison between lubricant formulations. The use of modern tribometers provides data that is more directly applicable to downhole friction mechanisms and lubricant performance expectations.

Insights from MTM and LEM testing helped facilitate development of aspects described herein. For example, traction testing provided absolute friction reduction under boundary-dominated conditions, while Stribeck analysis provided insight into lubrication regime transitions and film-forming behavior. LEM testing validated performance on representative wellbore surfaces and assessed tribofilm durability under sustained side-load contact.

Table 9 shows data for the reduction in COF using LEM and MTM measurement methods. MTM is the tribometer used to do the test, while timed run is heating to 200° F. and measuring characteristics while it cools. For these examples, the COF of water-based drilling mud compositions of the present disclosure was measured on a field sample of Bakken brine as aqueous carrier and either 1 vol % or 3 vol % concentration of a lubricant (Sample B1). The average COF was compared to the untreated sample to provide the percent reduction.

TABLE 9
COF % Reduction from Base with Lubricant Addition

| | LEM at 140° F. | |
|---|---|---|
| | (60° C.) | Timed run |
| Bakken brine with 1 vol % lubricant | 10.8% | 12.1% |
| Bakken brine with 3 vol % lubricant | 15.1% | 79.3% |
| | Stribeck at 150° F. | Stribeck at 200° F. |
| | (66° C.) | (93° C.) |
| Bakken brine with 1 vol % lubricant | 31.5% | 34.2% |
| Bakken brine with 3 vol % lubricant | 42.5% | 65.6% |
| | Traction at 150° F. | Traction at 200° F. |
| | (66° C.) | (93° C.) |
| Bakken brine with 1 vol % lubricant | 36.0% | 39.9% |
| Bakken brine with 3 vol % lubricant | 52.6% | 76.9% |

The results shown in Table 9 demonstrate that aspects of the present disclosure show reduction in wear and COF in both LEM and MTM measurements. Additionally, the results show the increased efficiency of lubricants described herein as temperatures increase more closely to downhole conditions with the greatest reduction coming at 200° F. (93° C.).

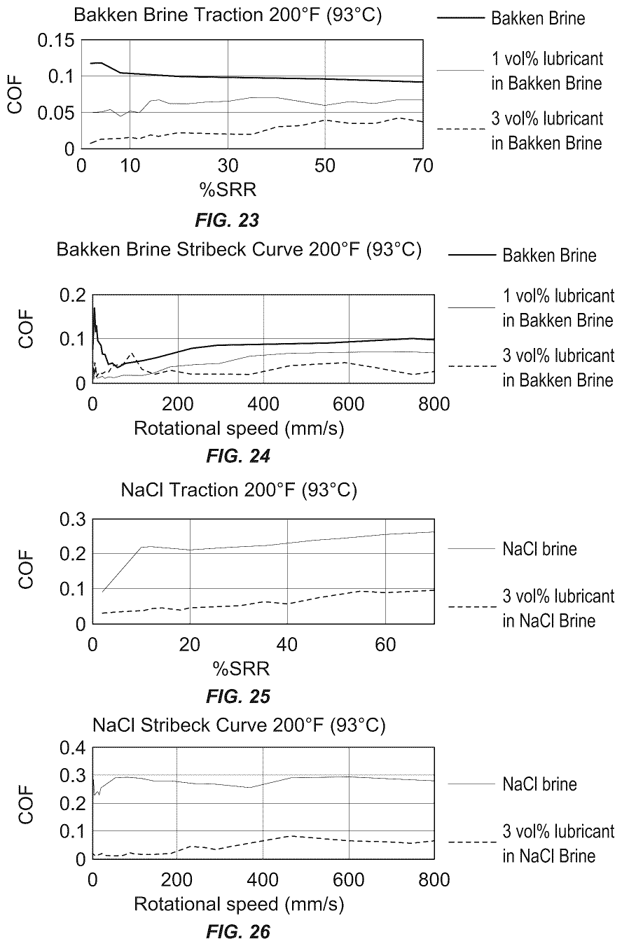

FIG. 23 is a plot showing COF versus slide-to-roll ratio of water-based drilling mud compositions that include Bakken brine as aqueous carrier and either 1 vol % or 3 vol % concentration of a lubricant (Sample B1). Bakken brine was used as a control. The data for the plot was measured using the MTM instrument. % SRR refers to percent slide to rotation ratio.

FIG. 24 is a plot showing COF versus rotational speed of water-based drilling mud compositions that include Bakken brine as aqueous carrier and either 1 vol % or 3 vol % concentration of a lubricant (Sample B1). Bakken brine was used as a control. The data for the plot was measured using the MTM instrument.

Both tests, with the data shown in FIG. 23 and FIG. 24 and completed on the MTM instrument, show consistent reductions in the COF throughout the duration of testing.

Additionally, testing was completed in various brines and water-based mud (WBM) formulations to ensure performance across multiple applications.

FIG. 25 is a plot showing COF versus slide-to-roll ratio of a water-based drilling mud composition that includes NaCl brine as aqueous carrier and 3 vol % concentration of a lubricant (Sample B1). NaCl brine was used as a control. The data for the plot was measured using the MTM instrument.

FIG. 26 is a plot showing COF versus rotational speed of a water-based drilling mud composition that includes NaCl brine as aqueous carrier and 3 vol % concentration of a lubricant (Sample B1). NaCl brine was used as a control. The data for the plot was measured using the MTM instrument.

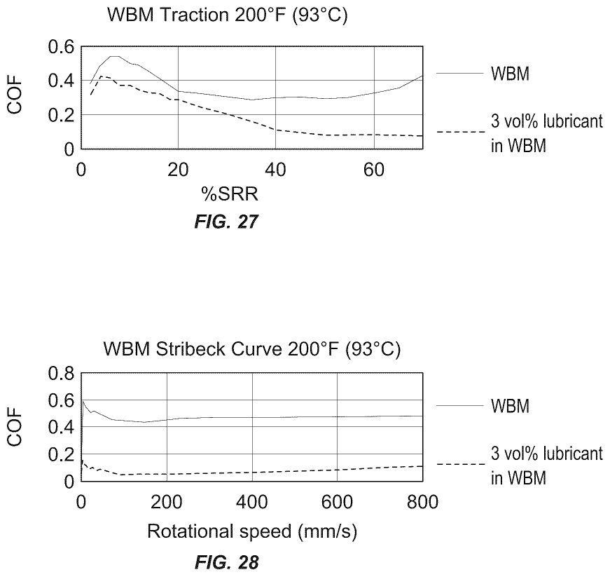

FIG. 27 is a plot showing COF versus slide-to-roll ratio of a water-based drilling mud composition that includes a bentonite water-based mud as aqueous carrier and 3 vol % concentration of a lubricant (Sample B1). The water-based mud (WBM) was used as a control. The data for the plot was measured using the MTM instrument.

FIG. 28 is a plot showing COF versus rotational speed of a water-based drilling mud composition that includes a bentonite water-based mud as aqueous carrier and 3 vol % concentration of a lubricant (Sample B1). The water-based mud (WBM) was used as a control. The data for the plot was measured using the MTM instrument.

The tests, with the data shown in FIG. 25, FIG. 26, FIG. 27, and FIG. 28 show consistent reductions in the COF throughout the duration of testing.

Overall, the results described with respect to Example 16 indicate that lubricants of the present disclosure and compositions that included lubricants of the present disclosure demonstrated consistent friction reduction, robust tribofilm formation, and broad compatibility with drilling fluids and brines commonly used in drilling operations. The development and deployment of lubricants described herein demonstrates a significant advancement in tribology driven drilling fluid technology for, e.g., unconventional shale applications. Laboratory testing across multiple brines and drilling fluid systems consistently showed reduced coefficients of friction, improved tribofilm formation, and enhanced thermal stability compared to traditional lubricants. Field implementation in the Bakken Basin further validated these benefits, yielding measurable reductions in torque, a 64% decrease in drill pipe wear, and enabling record lateral footage through one of the formation's most challenging intervals. These results confirm that the combination of micronized graphene, SAS, and a base oil lubricant can provide a durable and efficient lubrication mechanism suited for modern extended reach and high deviation drilling. By improving equipment longevity, reducing nonproductive time, and enhancing drilling efficiency, this multiphase lubricant can offer a meaningful contribution toward lowering overall well costs while supporting increasingly demanding operational environments.

Aspects of the present disclosure generally relate to new drilling compositions and uses thereof. As described, drilling mud compositions of the present disclosure can deliver exceptional wear reduction and friction control in, for example, high-demand drilling environments. Components of the drilling mud compositions can form a durable tribofilm that protects drill pipe surfaces from wear and tear under real-world conditions (e.g., extreme pressure and temperature conditions) such as those observed in the field. Drilling mud compositions described herein are characterized as having superior COF values relative to conventional drilling muds. For example, drilling mud compositions described herein can achieve a COF below 0.05, well beyond current industry standards. Drilling mud compositions described herein can offer several technical advantages relative to conventional drilling mud compositions. For example, the graphene present in drilling mud compositions of the present disclosure can serve to enhance lubricity and serve to be asperity filling. Further, drilling mud compositions described herein can provide sustained wear protection through tribofilm formation, can show broad compatibility with various pH levels and brine types, can show strong shear stability with reliable low-temperature performance, or combinations thereof. In addition, drilling mud compositions of the present disclosure can enhance operational efficiency and extend equipment life.

Drilling mud compositions described herein can be used to drill through hard formations and manage extreme downhole conditions. Under real-world conditions, and as described herein, drilling mud compositions of the present disclosure reduced drill pipe wear by 64% or more, even when drilling through tough rock. On another well, drilling mud compositions described herein were utilized to drill a 2-mile lateral in just 5.75 day. Overall, drilling mud compositions of the present disclosure can increase drilling efficiency, provide faster drilling rates, provide deeper drilling penetration into formations, protect equipment from wear, and/or extend drill pipe life relative to conventional drilling mud compositions.

### Aspects of the Disclosure

The present disclosure provides, among others, the following aspects, each of which can be considered as optionally including any alternate aspects:

Aspect 1. A water-based drilling mud composition, comprising: an aqueous carrier; asphalt sulfonate salt particles; graphene particles; and a base oil.

Aspect 2. The water-based drilling mud composition according to Aspect 1, wherein the asphalt sulfonate salt particles comprise sodium asphalt sulfonate particles, potassium asphalt sulfonate particles, or combinations thereof.

Aspect 3. The water-based drilling mud composition according to any one of Aspects 1 or 2, wherein the base oil comprises a C8 dimer, a C8 trimer, a C10 dimer, a C12 dimer, a C12 trimer, a C14 dimer, mixed C10-C12 dimers, a C14 hydrocarbon (for example, C14 reactor wash), a tall oil fatty acid, a polyalphaolefin (for example PAO-2), a GTL base oil (for example, Qatar GTL QHVI 3 oil), dodecene, dodecane, decene, decane, a monounsaturated fatty acid, or combinations thereof.

Aspect 4. The water-based drilling mud composition according to Aspect 3, wherein the monounsaturated fatty acid comprises oleic acid.

Aspect 5. The water-based drilling mud composition according to any one of the preceding Aspects, wherein the base oil has a kinematic viscosity (at 100° C.) of about 10 centistokes (cSt) or less, such as in a range from about 1 cSt to about 10 cSt, such as from about 2 cSt to about 9 cSt, such as from about 3 cSt to about 8 cSt, such as from about 4 cSt to about 7 cSt, such as from about 5 cSt to about 6 cSt.

Aspect 6. The water-based drilling mud composition according to any one of the preceding Aspects, wherein the base oil comprises a polyalphaolefin.

Aspect 7. The water-based drilling mud composition according to any one of the preceding Aspects, wherein the base oil comprises a polyalphaolefin derived from a C10-C12 alpha-olefin.

Aspect 8. The water-based drilling mud composition according to claim 1, wherein the base oil comprises a hydrogenated dimer of octene, a hydrogenated trimer of octene, a hydrogenated dimer of decene, a hydrogenated dimer of dodecene, a hydrogenated trimer of dodecene, or combinations thereof.

Aspect 9. The water-based drilling mud composition according to any one of the preceding Aspects, wherein the base oil comprises a polyalphaolefin derived from decene, such as 1-decene (for example, a hydrogenated dimer of 1-decene (for example, PAO-2)).

Aspect 10. The water-based drilling mud composition according to any one of the preceding Aspects, wherein the graphene particles comprise micronized graphene particles, nano-graphene particles, thin graphite, or combinations thereof.

Aspect 11. The water-based drilling mud composition according to Aspect 10, wherein the graphene particles have a D50 in a range from about 26 microns (μm) to about 50 μm, such as from about 30 μm to about 46 μm, such as from about 34 μm to about 42 μm, such as about 38 μm.

Aspect 12. The water-based drilling mud composition according to Aspect 10, wherein the graphene particles have a D50 in a range from about 1 μm to about 25 μm, such as from about 5 μm to about 21 μm, such as from about 9 μm to about 17 μm, such as about 13 μm; or a combination thereof.

Aspect 13. The water-based drilling mud composition according to any one of the preceding Aspects, wherein the graphene particles comprises micronized graphene particles.

Aspect 14. The water-based drilling mud composition according to any one of the preceding Aspects, wherein the water-based drilling mud composition comprises: an amount (by mass) of base oil that is greater than to an amount (by mass) of the graphene particles.

Aspect 15. The water-based drilling mud composition according to any one of the preceding Aspects, wherein the water-based drilling mud composition comprises: an amount (by mass) of the asphalt sulfonate salt particles that is greater than or equal to an amount (by mass) of the graphene particles; an amount (by mass) of the base oil that is greater than or equal to the amount of the asphalt sulfonate salt particles; or a combination thereof.

Aspect 16. The water-based drilling mud composition according to any one of the preceding Aspects, wherein the water-based drilling mud composition comprises: an amount (by mass) of the graphene particles that is greater than or equal to an amount of the asphalt sulfonate salt particles.

Aspect 17. The water-based drilling mud composition according to any one of the preceding Aspects, wherein the water-based drilling mud composition further comprises one or more materials, the one or more materials comprising a suspending agent, a surfactant, or combinations thereof.

Aspect 18. The water-based drilling mud composition according to Aspect 17, wherein, when the one or more materials comprises the suspending agent, the suspending agent comprises a styrene-containing polymer.

Aspect 19. The water-based drilling mud composition according to any one of Aspects 17-18, wherein, when the one or more materials comprises the surfactant, the surfactant comprises a non-ionic surfactant.

Aspect 20. The water-based drilling mud composition according to any one of the preceding Aspects, wherein the water-based drilling mud composition comprises:
(a) the aqueous carrier, an amount of the aqueous carrier in the water-based drilling mud composition is in a range from about 40 wt % to about 99 wt %, such as from about 95 wt % to about 99 wt %, such as from about 96 wt % to about 98 wt %, such as about 97 wt %, or from about 96 wt % to about 97 wt %, or from about 97 wt % to about 98 wt % based on a total weight of the aqueous carrier (a) and the mixture (b), the total weight of the aqueous carrier (a) and the mixture (b) equal to 100 wt %; and
(b) a mixture comprising the base oil, the asphalt sulfonate salt particles, and the graphene particles, and optionally one or more additional materials, an amount of the mixture in the water-based drilling mud composition is in a range from about 1 wt % to about 5 wt %, such as from about 2 wt % to about 4 wt %, such as about 3 wt %, or from about 3 wt % to about 4 wt %, or from about 2 wt % to about 3 wt %, or about 2 wt %, or about 3 wt %, or about 4 wt % based on the total weight of the aqueous carrier (a) and the mixture (b), the mixture (b) comprising:
   (b1) an amount of the base oil in the mixture is in a range from about 60 wt % to about 70 wt %, such as from about 61 wt % to about 69 wt %, such as from about 62 wt % to about 68 wt %, such as from about 63 wt % to about 67 wt %, such as from about 64 wt % to about 66 wt %, such as about 65 wt % based on a total weight of the mixture (b), the total weight of the mixture (b) equal to 100 wt %;
   (b2) an amount of the asphalt sulfonate salt particles in the mixture is in a range from greater than 0 wt % to about 25 wt %, such as from about 1 wt % to about 25 wt %, such as from about 5 wt % to about 25 wt %, such as from about 8 wt % to about 22 wt %, such as from about 11 wt % to about 19 wt %, such as from about 13 wt % to about 17 wt %, such as from about 14 wt % to about 16 wt %, such as about 15 wt % based on the total weight of the mixture (b); and
   (b3) an amount of the graphene particles in the mixture is in a range from greater than 0 wt % to about 25 wt %, such as from about 1 wt % to about 25 wt %, such as from about 5 wt % to about 25 wt %, such as from about 8 wt % to about 22 wt %, such as from about 11 wt % to about 19 wt %, such as from about 13 wt % to about 17 wt %, such as from about 14 wt % to about 16 wt %, such as about 15 wt % based on the total weight of the mixture (b).

Aspect 21. The water-based drilling mud composition according to Aspect 20, wherein the mixture (b) further comprises: (b4) an amount of the suspending agent is in a range from greater than 0 wt % to about 15 wt %, such as from about 1 wt % to about 15 wt %, such as from about 4 wt % to about 12 wt %, such as from about 7 wt % to about 9 wt %, such as about 9 wt %, or in a range from about 0.5 wt % to about 5 wt %, such as from about 1 wt % to about 4 wt %, such as from about 2 wt % to about 3 wt %, such as about 3 wt % based on a total weight of the mixture (b).

Aspect 22. The water-based drilling mud composition according to any one of Aspects 20-21, wherein the mixture (b) further comprises: (b5) an amount of the surfactant in the mixture is in a range from greater than 0 wt % to about 6 wt %, such as from about 0.5 wt % to about 5.5 wt %, such as from about 1 wt % to about 5 wt %, such as from about 2 wt % to about 4 wt %, such as about 3 wt % based on a total weight of the mixture (b).

Aspect 23. The water-based drilling mud composition according to any one of the preceding Aspects, wherein the water-based drilling mud composition has a lower COF than a composition without one or more of the asphalt sulfonate salt particles, the base oil, or the graphene particles.

Aspect 24. The water-based drilling mud composition according to any one of the preceding Aspects, wherein the water-based drilling mud composition is characterized as having super-lubricity (for example, a COF of less than 0.1 as measured according to ASTM G-99-23).

Aspect 25. The water-based drilling mud composition according to any one of the preceding Aspects, wherein the water-based drilling mud composition has a COF (measured at 200° F. and at a rotating speed of 1-1,200 mm/s according to ASTM Designation G-99-23) of less than 0.1, such as in a range from about 0.01 to about 0.09, such as from about 0.02 to about 0.08, such as from about 0.03 to about 0.07, such as from about 0.04 to about 0.06, such as from about 0.046 to about 0.048, or from about 0.026 to about 0.068, such as from about 0.027 to about 0.061, such as from about 0.031 to about 0.048.

Aspect 26. The water-based drilling mud composition according to any one of the preceding Aspects, wherein the water-based drilling mud composition has a COF (measured at 200° F. and at a rotating speed of 1-1,200 mm/s according to ASTM Designation G-99-23) of about 0.05 or less, such as in a range from about 0.03 to about 0.05, such as from about 0.04 to about 0.05.

Aspect 27. The water-based drilling mud composition according to any one of the preceding Aspects, wherein the water-based drilling mud composition has a COF (measured at 150° F. and at a rotating speed of 1-1,200 mm/s according to ASTM Designation G-99-23) of less than 0.1, such as in a range from about 0.037 to about 0.078, such as from about 0.044 to about 0.071, such as from about 0.051 to about 0.064, such as from about 0.054 to about 0.061.

Aspect 28. The water-based drilling mud composition according to any one of the preceding Aspects, wherein the water-based drilling mud composition has a COF (measured at 100° F. and at a rotating speed of 1-1,200 mm/s according to ASTM Designation G-99-23) of less than 0.1, such as in a range from about 0.044 to about 0.087, such as from about 0.05 to about 0.08, such as from about 0.058 to about 0.074, such as from about 0.064 to about 0.067.

Aspect 29. The water-based drilling mud composition according to any one of the preceding Aspects, wherein the water-based drilling mud composition has a COF (measured at 200° F. and at a rotating speed of 1.4 mm/s) of about 0.09 or less, about 0.08 or less, about 0.07 or less, about 0.06 or less, or about 0.055 or less, such as about 0.052 or less.

Aspect 30. The water-based drilling mud composition according to any one of the preceding Aspects, wherein the water-based drilling mud composition has a COF (measured at 200° F. and at a rotating speed of 6.5 mm/s) of about 0.09 or less, about 0.08 or less, about 0.07 or less, about 0.06 or less, or about 0.05 or less, such as about 0.045 or less, such as about 0.043 or less.

Aspect 31. The water-based drilling mud composition according to any one of the preceding Aspects, wherein the water-based drilling mud composition has a COF (measured at 200° F. and at a rotating speed of 21 mm/s) of about 0.07 or less, about 0.06 or less, about 0.05 or less, such as about 0.045 or less.

Aspect 32. The water-based drilling mud composition according to any one of the preceding Aspects, wherein the water-based drilling mud composition has a COF (measured at 200° F. and at a rotating speed of 34 mm/s) of about 0.08 or less, such as about 0.07 or less, about 0.06 or less, about 0.05 or less, such as about 0.046 or less.

Aspect 33. The water-based drilling mud composition according to any one of the preceding Aspects, wherein the water-based drilling mud composition has a COF (measured at 200° F. and at a rotating speed of 70 mm/s) of about 0.09 or less, such as about 0.08 or less, such as about 0.07 or less, about 0.06 or less, about 0.056 or less, such as about 0.05 or less, such as about 0.045 or less, such as about 0.04 or less, such as about 0.035 or less.

Aspect 34. The water-based drilling mud composition according to any one of the preceding Aspects, wherein the water-based drilling mud composition has a COF (measured at 200° F. and at a rotating speed of 112 mm/s) of about 0.09 or less, such as about 0.08 or less, such as about 0.07 or less, about 0.06 or less, about 0.056 or less, such as about 0.05 or less, such as about 0.045 or less, such as about 0.04 or less, such as about 0.039 or less.

Aspect 35. The water-based drilling mud composition according to any one of the preceding Aspects, wherein the water-based drilling mud composition is characterized as having super-lubricity in a boundary lubrication regime (for example, low rotating speeds in a range from greater than 0 mm/s to about 100 mm/s).

Aspect 36. The water-based drilling mud composition according to any one of the preceding Aspects, wherein: the base oil reduces shear stress between two or more layers of the graphene particles; the base oil facilitates sliding, movement, or a combination thereof between two or more layers of the graphene particles; or a combination thereof.

Aspect 37. The water-based drilling mud composition according to any one of the preceding Aspects, wherein the base oil promotes stabilization of water-based drilling mud composition by stabilizing an interface between the asphalt sulfonate salt particles and the graphene particles.

Aspect 38. The water-based drilling mud composition according to any one of the preceding Aspects, wherein: two or more layers of the asphalt sulfonate salt particles form scrolls, reducing a contact area between the asphalt sulfonate salt particles and one or more other components of the water-based drilling mud composition; two or more layers of the graphene particles form scrolls (for example, nanoscrolls), reducing a contact area between the graphene particles and one or more other components of the water-based drilling mud composition; the graphene particles form an envelope around the asphalt sulfonate salt particles sliding over a film of the base oil; or combinations thereof.

Aspect 39. The water-based drilling mud composition according to any one of the preceding Aspects, wherein: at least a portion of the asphalt sulfonate salt particles minimizes contact with one or more other components of the water-based drilling mud composition; at least a portion of the graphene particles has minimal surface area to contact one or more other components of the water-based drilling mud composition; or combinations thereof.

Aspect 40. The water-based drilling mud composition according to any one of the preceding Aspects, wherein at least a portion of the graphene particles facilitate movement of the asphalt sulfonate salt particles over the base oil;

Aspect 41. The water-based drilling mud composition according to any one of the preceding Aspects, wherein the water-based drilling mud composition has a COF that decreases with increasing temperature from 100° F. to 200° F.

Aspect 42. The water-based drilling mud composition according to any one of the preceding Aspects, wherein the water-based drilling mud composition comprises: a concentration of the asphalt sulfonate salt particles in a range from about 15 lbm/bbl to about 25 lbm/bbl, such as from about 17 lbm/bbl to about 23 lbm/bbl, such as from about 19 lbm/bbl to about 21 lbm/bbl, such as about 20 lbm/bbl.

Aspect 43. The water-based drilling mud composition according to any one of the preceding Aspects, wherein the water-based drilling mud composition comprises a concentration of the graphene particles that is about 15 lbm/bbl or less, such as in a range from about 1 lbm/bbl to about 15 lbm/bbl, such as from about 5 lbm/bbl to about 15 lbm/bbl, such as from about 7 lbm/bbl to about 13 lbm/bbl, such as from about 9 lbm/bbl to about 11 lbm/bbl, such as about 10 lbm/bbl.

Aspect 44. The water-based drilling mud composition according to any one of the preceding Aspects, wherein the aqueous carrier comprises water, brine, or combinations thereof.

Aspect 45. The water-based drilling mud composition according to Aspect 44, wherein the brine comprises a calcium chloride brine.

Aspect 46. The water-based drilling mud composition according to any one of Aspects 44-45, wherein the brine comprises sea water, a Permian Basin brine, a Bakken brine, production water generated from oil-gas exploration, or combinations thereof.

Aspect 47. The water-based drilling mud composition according to any one of the preceding Aspects, wherein the water-based drilling mud composition reduces replacement of pipe wear bands by at least 20% relative to a drilling mud composition without the graphene particles, such as by at least 30%, at least 40%, at least 50%, at least 55%, at least 60%, or at least 64%.

Aspect 48. The water-based drilling mud composition according to any one of the preceding Aspects, wherein the asphalt sulfonate salt particles, graphene particles, the base oil, or combinations thereof do not, or substantially do not, grease out or cheese out in the presence of the aqueous carrier (for example, an aqueous carrier fluid containing monovalent ions, divalent ions, trivalent ions, or combinations thereof.

Aspect 49. A water-based drilling mud composition, comprising: an aqueous carrier; asphalt sulfonate salt particles; graphene particles; and a base oil, the water-based drilling mud composition having: a COF (measured at 100° F.) that is at least 5% less than a COF of the water-based drilling mud composition without the graphene particles; a COF (measured at 150° F.) that is at least 5% less than a COF of the water-based drilling mud composition without the graphene particles; a COF (measured at 200° F.) that is at least 5% less than a COF of the water-based drilling mud composition without the graphene particles; or combinations thereof, the COF measured according to ASTM Designation G-99-23.

Aspect 50. The water-based drilling mud composition according to Aspect 49, wherein the water-based drilling mud composition comprises the water-based drilling mud composition according to any one of Aspects 1-48.

Aspect 51. The water-based drilling mud composition according to any one of Aspects 49-50, wherein: the COF of the water-based drilling mud composition, measured at 100° F., is at least 10% less, at least 15% less, at least 20% less, at least 22% less, or at least 25% less than the COF of the water-based drilling mud composition without the graphene particles; the COF of the water-based drilling mud composition, measured at 150° F., is at least 7.5% less, at least 10% less, at least 15% less, or at least 18% less, than the COF of the water-based drilling mud composition without the graphene particles; the COF of the water-based drilling mud composition, measured at 200° F., is at least 10% less, at least 15% less, at least 20% less, at least 22% less, at least 25% less, at least 26% less, or at least 29% less than the COF of the water-based drilling mud composition without the graphene particles; or combinations thereof.

Aspect 52. A water-based drilling mud composition, having: a COF, measured at 100° F., of about 0.06 or less; a COF, measured at 150° F., of about 0.07 or less; a COF, measured at 200° F., of about 0.04 or less; or combinations thereof, the COF measured according to ASTM Designation G-99-23.

Aspect 53. The water-based drilling mud composition according to Aspect 52, comprising graphene particles.

Aspect 54. The water-based drilling mud composition according to any one of Aspects 52-53, comprising asphalt sulfonate salt particles.

Aspect 55. The water-based drilling mud composition according to any one of Aspects 52-54, comprising a base oil.

Aspect 56. The water-based drilling mud composition according to any one of Aspects 52-55, comprising an aqueous carrier.

Aspect 57. A composition, comprising: an aqueous material or an oil-based material; asphalt sulfonate salt particles; graphene particles; and a base oil, the base oil different from the oil-based material.

Aspect 58. The composition according to Aspect 57, wherein the composition comprises the water-based drilling mud composition according to any one of Aspects 1-56.

Aspect 59. An oil-based drilling mud composition, comprising: an oil-based carrier (for example, diesel oil, mineral oil, synthetic oil, or combinations thereof); asphalt sulfonate salt particles; graphene particles; and a base oil, the base oil different from the oil-based carrier.

Aspect 60. A process, comprising: using a composition comprising asphalt sulfonate salt particles, graphene particles, and a base oil as a drilling fluid, or as a coiled-tubing fluid, or as a wellbore fluid, or as a kill mud composition, or as a completion fluid.

Aspect 61. The process according to Aspect 60, wherein the composition further comprises: an aqueous carrier; or an oil-based carrier that is different from the base oil.

Aspect 62. The process according to any one of Aspects 60-61, wherein the composition comprises the composition according to any one of Aspects 1-59.

Aspect 63. A process, comprising: introducing a composition comprising asphalt sulfonate salt particles, graphene particles, and a base oil to a subterranean formation; and optionally producing a natural resource (e.g., oil, gas, and/or water) from the subterranean formation.

Aspect 64. The process according to Aspect 63, wherein the composition further comprises: an aqueous carrier; or an oil-based carrier that is different from the base oil.

Aspect 65. The process according to any one of Aspects 63-64, wherein the composition comprises the composition according to any one of Aspects 1-59.

Aspect 66. A method of preparing a water-based drilling mud composition, comprising: emulsifying a precursor composition comprising an aqueous carrier, asphalt sulfonate salt particles, graphene particles, and a base oil to form a water-based drilling mud composition.

Aspect 67. The method according to Aspect 66, wherein the water-based drilling mud composition comprises the water-based drilling mud composition according to any one of Aspects 1-58.

Aspect 68. A drilling mud composition, comprising: a concentration of asphalt sulfonate salt particles, a concentration of graphene particles, and a concentration of base oil, wherein the concentration of base oil is greater than or equal to the concentration of asphalt sulfonate salt particles and the concentration of the graphene particles.

Aspect 69. The drilling mud composition according to Aspect 68, wherein the asphalt sulfonate salt particles comprise sodium asphalt sulfonate particles, potassium asphalt sulfonate particles, or combinations thereof.

Aspect 70. The drilling mud composition according to any one of Aspects 68-69, wherein the concentration of asphalt sulfonate salt particles is greater than or equal to the concentration of graphene.

Aspect 71. The drilling mud composition according to any one of Aspects 68-70, wherein the graphene particles comprise micronized graphene particles, nano-graphene particles, thin graphite, or combinations thereof, the base oil comprises a PAO, the PAO comprising mixed C10-C12 dimers (e.g., Synfluid® Mixed Dimer), PAO-2 (e.g., Synfluid® PAO-2); or combinations thereof.

Aspect 72. The drilling mud composition according to any one of Aspects 68-71, wherein the concentration of the base oil is in a range from about 1 lbm/bbl to about 2.5 lbm/bbl, such as about 1.75 lbm/bbl.

Aspect 73. The drilling mud composition according to any one of Aspects 68-72, wherein the concentration of the graphene particles is in a range from about 1 lbm/bbl to about 8 lbm/bbl, such as about 1.75 lbm/bbl.

Aspect 74. The drilling mud composition according to any one of Aspects 68-73, wherein the concentration of the graphene particles is in a range from about 1.0 lbm/bbl to about 4.25 lbm/bbl, such as about 1.5 lbm/bbl.

Aspect 75. The drilling mud composition according to any one of Aspects 68-74, wherein the base oil comprises PAO-2.

Aspect 76. The drilling mud composition according to any one of Aspects 68-75, wherein the drilling mud composition has a COF (100° F.; 1-1,200 mm/s rotating speed; ASTM G-99-23) in a range from about 0.048 to about 0.135, such as from about 0.057 to about 0.135, such as from about 0.092 to about 0.097, while a control has a COF (100° F.; 1-1,200 mm/s rotating speed; ASTM G-99-23) in a range from about 0.248 to about 0.28. The control is a base mud composition (“base”) as described in the Examples.

Aspect 77. The drilling mud composition according to any one of Aspects 68-76, wherein the drilling mud composition has a COF (measured at: 150° F.; 1-1,200 mm/s rotating speed; ASTM G-99-23) in a range from about 0.056 to about 0.132, such as from about 0.067 to about 0.132, such as from about 0.072 to about 0.082, while a control has a COF (150° F.; 1-1,200 mm/s rotating speed; ASTM G-99-23) in a range from about 0.149 to about 0.245. The control is a base mud composition (“base”) as described in the Examples.

Aspect 78. The drilling mud composition according to any one of Aspects 68-77, wherein the drilling mud composition has a COF (measured at: 200° F.; 1-1,200 mm/s rotating speed; ASTM G-99-23) in a range from about 0.052 to about 0.145, such as from about 0.057 to about 0.140, such as from about 0.067 to about 0.097, while a control has a COF (200° F.; 1-1,200 mm/s rotating speed; ASTM G-99-23) in a range from about 0.152 to about 0.215. The control is a base mud composition (“base”) as described in the Examples.

Aspect 79. The drilling mud composition according to any one of Aspects 68-78, wherein the drilling mud composition has an average COF (at 100° F.) that is from about 0.050 to about 0.084, such as about 0.067.

Aspect 80. The drilling mud composition according to any one of Aspects 68-79, wherein the drilling mud composition has an average COF (at 150° F.) that is from about 0.044 to about 0.078, such as about 0.061.

Aspect 81. The drilling mud composition according to any one of Aspects 68-80, wherein the drilling mud composition has an average COF (at 200° F.) that is from about 0.024 to about 0.058, such as about 0.041.

Aspect 82. The drilling mud composition according to any one of Aspects 68-81, wherein, after the drilling mud is heated to a temperature of 200° F., the COF varies with time over a period of 0-900 seconds, the COF varying in a range from about 0.037 to about 0.049 (PAO-2+graphene), or from about 0.041 to about 0.079 (graphene).

Aspect 83. The drilling mud composition according to any one of Aspects 68-82, wherein the base oil comprises PAO-5.

Aspect 84. The drilling mud composition according to Aspect 83, wherein the drilling mud composition has a COF (100° F.; 1-1,200 mm/s rotating speed; ASTM G-99-23) in a range from about 0.049 to about 0.101, such as from about 0.067 to about 0.097, while a control has a COF (100° F.; 1-1,200 mm/s rotating speed; ASTM G-99-23) in a range from about 0.181 to about 0.281. The control is a base mud composition (“base”) as described in the Examples.

Aspect 85. The drilling mud composition according to any one of Aspects 83-84, wherein the drilling mud composition has a COF (measured at: 150° F.; 1-1,200 mm/s rotating speed; ASTM G-99-23) in a range from about 0.046 to about 0.072 or from about 0.065 to about 0.082, while a control has a COF (150° F.; 1-1,200 mm/s rotating speed; ASTM G-99-23) in a range from about 0.149 to about 0.245. The control is a base mud composition (“base”) as described in the Examples.

Aspect 86. The drilling mud composition according to any one of Aspects 83-85, wherein the drilling mud composition has a COF (measured at: 200° F.; 1-1,200 mm/s rotating speed; ASTM G-99-23) in a range from about 0.041 to about 0.055, such as from about 0.051 to about 0.055, or from about 0.063 to about 0.097, while a control has a COF (200° F.; 1-1,200 mm/s rotating speed; ASTM G-99-23) in a range from about 0.073 to about 0.215. The control is a base mud composition (“base”) as described in the Examples.

Aspect 87. A water-based drilling mud composition, comprising: an oil suspension dispersed in an aqueous carrier, asphalt sulfonate salt particles, graphene particles, an optional surfactant, and an optional suspending agent (e.g., a polymer), the oil suspension comprising a PAO, a mixed C10-C12 dimer, tall oil fatty acid, a C14 hydrocarbon, a GTL base oil, or combinations thereof.

Aspect 88. An oil-based drilling mud composition comprising: from about 40 wt % to about 99.9 wt %, such as about 96 wt % of an oil based carrier; and from about 0.1 wt % to about 5 wt %, such as about 4 wt % of a blend comprising PAO, SAS particles, and graphene particles.

Aspect 89. A method of reducing torque and drag on drilling equipment when drilling, the method comprising:
introducing a composition comprising asphalt sulfonate salt particles, graphene particles, and a base oil to drilling equipment in a subterranean formation; and
causing movement of the drilling equipment, wherein the movement of the drilling equipment experiences less torque and drag than movement of the drilling equipment without the composition.

Aspect 90. The method according to Aspect 89, wherein the composition comprises the composition according to any one of Aspects 1-59 or Aspects 68-88.

Aspect 91. A method of forming a tribofilm on drilling equipment (for example, a drill pipe surface), the method comprising:
introducing a composition comprising asphalt sulfonate salt particles, graphene particles, and a base oil to drilling equipment to form a tribofilm on a surface of the drilling equipment; and
optionally, causing movement and/or rotation of the drilling equipment, the movement and/or rotation of the drilling equipment causing components of the composition (e.g., the SAS particles, graphene particles, and/or base oil) to interact to form a tribofilm on a surface of the drilling equipment (e.g., causing components of the composition to interact under shear to form a tribofilm on a metallic surface of the drilling equipment).

Aspect 92. The method according to Aspect 91, wherein the composition comprises the composition according to any one of Aspects 1-59 or Aspects 68-88.

Aspect 93. A method of drilling an extended lateral wellbore, the method comprising:
introducing a composition comprising asphalt sulfonate salt particles, graphene particles, and a base oil to drilling equipment in a subterranean formation; and
optionally, drilling an extended lateral wellbore with the equipment.

Aspect 94. The method according to Aspect 93, wherein the composition comprises the composition according to any one of Aspects 1-59 or Aspects 68-88.

In the foregoing, reference is made to aspects of the disclosure. However, it should be understood that the disclosure is not limited to specific described aspects. Instead, any combination of the following features and elements, whether related to different aspects or not, is contemplated to implement and practice the disclosure. Furthermore, although aspects of the disclosure can achieve advantages over other possible solutions and/or over the prior art, whether or not a particular advantage is achieved by a given aspect is not limiting of the disclosure. Thus, the foregoing aspects, features, embodiments, implementations, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a formulation, a composition, an element or a group of elements is preceded with the transitional phrase “comprising,” it is understood that we also contemplate the same formulation, composition or group of elements with transitional phrases “consisting essentially of,” “consisting of,” “selected from the group of consisting of,” or “Is” preceding the recitation of the formulation, composition, element, or elements and vice versa, for example, the terms “comprising,” “consisting essentially of,” “consisting of” also include the product of the combinations of elements listed after the term.

References cited herein are incorporated by reference herein in their entirety to indicate the state of the art as of their publication or filing date and it is intended that this information can be employed herein, if desired, to exclude specific aspects that are in the prior art.

For purposes of this present disclosure, and unless otherwise specified, all numerical values within the detailed description and the claims herein are modified by “about” or “approximately” the indicated value, and consider experimental error and variations that would be expected by a person having ordinary skill in the art. It will be further understood that there are a number of values disclosed therein, and that each value is also herein disclosed as “about” that particular value in addition to the value itself. In aspects, use of the term “about” can refer to ±20% of the stated value, ±15% of the stated value, ±10% of the stated value, ±5% of the stated value, ±3% of the stated value, ±2% of the stated value, or ±1% of the stated value.

For the sake of brevity, only certain ranges are explicitly disclosed herein. However, ranges from any lower limit can be combined with any upper limit to recite a range not explicitly recited, as well as, ranges from any lower limit can be combined with any other lower limit to recite a range not explicitly recited, in the same way, ranges from any upper limit can be combined with any other upper limit to recite a range not explicitly recited. Additionally, within a range includes every point or individual value between its end points even though not explicitly recited. Thus, every point or individual value can serve as its own lower or upper limit combined with any other point or individual value or any other lower or upper limit, to recite a range not explicitly recited. For example, by disclosing a temperature of from 70° C. to 80° C., an intent is to recite individually 70° C., 71° C., 72° C., 73° C., 74° C., 75° C., 76° C., 77° C., 78° C., 79° C., and 80° C., including any sub-ranges and combinations of sub-ranges encompassed therein such that any of the foregoing numbers can be used singly to describe an open-ended range or in combination to describe a close-ended range. As another example, by disclosing graphene concentration from about 5 lbm/bbl to about 15 lbm/bbl Applicant's intent is to recite individually 5, 6, 7, 8, 9, 10, 11, 12, 13, 14, 15 including any individual whole number between and including 5 and 15, sub-ranges and combinations of sub-ranges encompassed therein, and these methods of describing such ranges are interchangeable

Moreover, all numerical end points of ranges disclosed herein are approximate, unless excluded by proviso. As a representative example, if one or more operations in the processes described herein can be conducted at a temperature in a range from 10° C. to 75° C., this range should be interpreted as encompassing temperatures in a range from “about” 10° C. to “about” 75° C.

As used herein, the indefinite article “a” or “an” shall mean “at least one” unless specified to the contrary or the context clearly indicates otherwise. For example, aspects comprising “a base oil” include aspects comprising one, two, or more base oils, unless specified to the contrary or the context clearly indicates only one base oil is included. For example, aspects comprising “a C12+ hydrocarbon” include aspects comprising one, two, or more C12+ hydrocarbons, unless specified to the contrary or the context clearly indicates only one hydrocarbon is included.

When a compound is described herein such that a particular isomer, enantiomer, or diastereomer of the compound is not specified, for example, in a formula or in a chemical name, that description is intended to include each isomer and enantiomer of the compound described individual or in any combination. For example, any general structure, formula, or name presented is also intended to encompass all structural isomers, conformational isomers, regioisomers, stereoisomers (such as enantiomers, diastereomers, and other optical isomers whether in enantiomeric or racemic forms, as well as mixtures of stereoisomers, as the context permits or requires) that can arise from a particular set of substituents, unless indicated otherwise. Thus, a general reference to a compound includes all structural isomers unless specified to the contrary or the context clearly indicates otherwise. For example, reference to a hydrocarbon without specifying a particular isomer (such as butyl) expressly discloses all isomers (such as n-butyl, iso-butyl, sec-butyl, and tert-butyl). For example, reference to a C5 hydrocarbon expressly discloses all isomers thereof.

The term “polymer” is used herein generically to include homopolymers, copolymers, terpolymers, and so forth, such as olefin homopolymers, copolymers, terpolymers, and the like. A copolymer can be derived from an olefin monomer and one olefin comonomer, while a terpolymer can be derived from an olefin monomer and two olefin comonomers. Accordingly, “polymer” encompasses copolymers, terpolymers, etc., derived from any olefin monomer and comonomer(s) disclosed herein. Similarly, an ethylene polymer would include ethylene homopolymers, ethylene copolymers, ethylene terpolymers, and the like. As an example, an olefin polymer (polyolefin), such as an ethylene copolymer, can be derived from ethylene and a comonomer, such as 1-butene, 1-hexene, or 1-octene. If the monomer and comonomer were ethylene and 1-hexene, respectively, the resulting polymer could be categorized as an ethylene/1-hexene copolymer or a poly(ethylene-co-1-hexene) polymer.

While the foregoing is directed to aspects of the present disclosure, other and further aspects of the disclosure can be devised without departing from the basic scope thereof, and the scope thereof is determined by the claims that follow.

1. A water-based drilling mud composition, comprising:
an aqueous carrier;
asphalt sulfonate salt particles;
graphene particles; and
a base oil, wherein the graphene particles and the base oil are dispersed in the composition to promote stability of an emulsion.

2. The water-based drilling mud composition according to claim 1, wherein the asphalt sulfonate salt particles comprise sodium asphalt sulfonate particles, potassium asphalt sulfonate particles, or combinations thereof.

3. The water-based drilling mud composition according to claim 1, wherein the base oil comprises a C8 dimer, a C8 trimer, a C10 dimer, a C12 dimer, a C12 trimer, a C14 dimer, mixed C10-C12 dimers, a C14 hydrocarbon, a tall oil fatty acid, a polyalphaolefin, a GTL base oil, dodecene, dodecane, decane, decene, a monounsaturated fatty acid, or combinations thereof.

4. The water-based drilling mud composition according to claim 3, wherein the monounsaturated fatty acid comprises oleic acid.

5. The water-based drilling mud composition according to claim 1, wherein the base oil has a kinematic viscosity (at 100° C.) in a range from about 1 cSt to about 10 cSt.

6. The water-based drilling mud composition according to claim 1, wherein the base oil comprises a hydrogenated dimer of octene, a hydrogenated trimer of octene, a hydrogenated dimer of decene, a hydrogenated dimer of dodecene, a hydrogenated trimer of dodecene, or combinations thereof.

7. The water-based drilling mud composition according to claim 1, wherein the graphene particles comprise micronized graphene particles, nano-graphene particles, thin graphite, or combinations thereof.

8. The water-based drilling mud composition according to claim 7, wherein:
the micronized graphene particles have a D50 in a range from about 26 μm to about 50 μm;
the nano-graphene particles have a D50 in a range from about 1 μm to about 25 μm; or
a combination thereof.

9. The water-based drilling mud composition according to claim 1, wherein the water-based drilling mud composition further comprises one or more materials, the one or more materials comprising a suspending agent, a surfactant, or combinations thereof.

10. The water-based drilling mud composition according to claim 1, wherein the water-based drilling mud composition comprises an amount (by mass) of the asphalt sulfonate salt particles that is greater than or equal to an amount (by mass) of the graphene particles.

11. The water-based drilling mud composition according to claim 1, wherein the water-based drilling mud composition comprises:
a mixture comprising the base oil, the asphalt sulfonate salt particles, the graphene particles, and optionally one or more additional materials, an amount of the mixture in the water-based drilling mud composition is in a range from about 1 wt % to about 5 wt %.

12. The water-based drilling mud composition according to claim 11, wherein the mixture comprises:
an amount of the base oil in a range from about 60 wt % to about 70 wt % based on a total weight of the mixture, the total weight of the mixture equal to 100 wt %;
an amount of the asphalt sulfonate salt particles in a range from about 1 wt % to about 25 wt % based on the total weight of the mixture; and
an amount of the graphene particles in a range from about 1 wt % to about 25 wt % based on the total weight of the mixture.

13. The water-based drilling mud composition according to claim 11, wherein the mixture further comprises a suspending agent in a range from greater than 0 wt % to about 15 wt % based on a total weight of the mixture.

14. The water-based drilling mud composition according to claim 11, wherein the mixture further comprises a surfactant in a range from greater than 0 wt % to about 6 wt % based on a total weight of the mixture.

15. The water-based drilling mud composition according to claim 1, wherein the water-based drilling mud composition has a COF (measured at 200° F. and at a rotating speed of 1-1,200 mm/s according to ASTM Designation G-99-23) of less than 0.1.

16. The water-based drilling mud composition according to claim 1, wherein the water-based drilling mud composition has a COF (measured at 100° F. and at a rotating speed of 1-1,200 mm/s according to ASTM Designation G-99-23) of less than 0.1.

17. The water-based drilling mud composition according to claim 1, wherein the aqueous carrier comprises water, brine, or combinations thereof.

18. The water-based drilling mud composition according to claim 17, wherein the brine comprises a calcium chloride brine, sea water, a Permian Basin brine, a Bakken brine, production water generated from oil-gas exploration, or combinations thereof.

19. The water-based drilling mud composition according to claim 1, wherein the water-based drilling mud composition reduces replacement of pipe wear bands by at least 20% relative to a drilling mud composition without the graphene particles.

20. The water-based drilling mud composition according to claim 1, wherein the asphalt sulfonate salt particles, the graphene particles, the base oil, or combinations thereof do not grease out or cheese out in the presence of the aqueous carrier.

21. A process, comprising:
introducing a composition comprising asphalt sulfonate salt particles, graphene particles, and a base oil to a subterranean formation.

22. The process according to claim 21, wherein the base oil comprises a C8 dimer, a C8 trimer, a C10 dimer, a C12 dimer, a C12 trimer, a C14 dimer, mixed C10-C12 dimers, a C14 hydrocarbon, a tall oil fatty acid, a polyalphaolefin, a GTL base oil, dodecene, dodecane, decane, decene, a monounsaturated fatty acid, or combinations thereof.

23. The process according to claim 22, wherein the monounsaturated fatty acid comprises oleic acid.

24. The process according to claim 21, wherein the base oil comprises a hydrogenated dimer of octene, a hydrogenated trimer of octene, a hydrogenated dimer of decene, a hydrogenated dimer of dodecene, a hydrogenated trimer of dodecene, or combinations thereof.

25. A water-based drilling mud composition, comprising:
an aqueous carrier;
asphalt sulfonate salt particles;
graphene particles; and
a base oil,
wherein the graphene particles and the base oil are dispersed in the composition to promote stability of an emulsion, and wherein the water-based drilling mud composition has a COF (measured at 100° F.) that is at least 5% less than a COF of the water-based drilling mud composition without the graphene particles.

26. A method of reducing torque and drag on drilling equipment when drilling, the method comprising:
introducing a composition comprising asphalt sulfonate salt particles, graphene particles, and a base oil to drilling equipment in a subterranean formation; and
causing movement of the drilling equipment, wherein the movement of the drilling equipment experiences less torque and drag than movement of the drilling equipment without the composition.

27. A method of forming a tribofilm on drilling equipment, the method comprising:
introducing a composition comprising asphalt sulfonate salt particles, graphene particles, and a base oil to drilling equipment to form a tribofilm on a surface of the drilling equipment.

28. A method of drilling an extended lateral wellbore, the method comprising:
introducing a composition comprising asphalt sulfonate salt particles, graphene particles, and a base oil to drilling equipment in a subterranean formation; and
drilling an extended lateral wellbore with the drilling equipment in the subterranean formation.
